(19) United States
(12) Patent Application Publication
(10) Pub. No.: US 2026/0296845 A1
(43) Pub. Date: Oct. 1, 2026

(54) WIND TURBINE MOUNTED CRANE

(71) Applicant: LIFTRA IP APS, Aalborg SV (DK)

(72) Inventors: Per Eske FENGER, Terndrup (DK); Rasmus STENGAARD, Aalborg (DK)

(73) Assignee: LIFTRA IP APS, Aalborg SV (DK)

(21) Appl. No.: 19/478,687

(22) PCT Filed: Apr. 24, 2024
(86) PCT No.: PCT/EP2024/061327

§ 371 Date: Oct. 24, 2025

(30) Foreign Application Priority Data
Apr. 24, 2023 (DK) PA202370193

(51) Int. Cl. B66C 23/20; B66C 23/18; B66C 23/84; B66D 3/08

(52) U.S. Cl. CPC B66C 23/207; B66C 23/185; B66C 23/84; B66D 3/08

(57) ABSTRACT

A wind turbine mounted crane comprising a base portion, and a wind turbine connection mechanism connected to the base portion and configured to releasably engage with a wind turbine. The crane also includes a boom arm rotatably connected to the base portion about a vertical axis, a lifting hook, a first and second lifting wire running through the base portion and connected to the lifting hook. At least one winch is connected to the first and second lifting wires. The winch and lifting wires are arranged such that when the winch is rotated, the lifting hook moves. The boom arm is configured to rotate about the vertical axis relative to the base portion by more than 180 degrees from an initial position in a first direction and more than 180 degrees from the initial position in a second direction opposite to the first direction. In this way, a crane is provided which has a greater area of operation when compared to prior art type cranes.

### TECHNICAL FIELD OF THE INVENTION

The current invention generally concerns wind turbine mounted cranes. More particularly, the invention relates to a wind turbine mounted crane configured to facilitate an installation, a maintenance and/or a repair of a wind turbine.

The current specification also discloses additional inventions related to systems comprising a wind turbine mounted crane as well as methods involving the use of a wind turbine mounted crane.

### BACKGROUND OF THE INVENTION

Typically, when doing maintenance and/or construction of a wind turbine or when doing maintenance of a previously installed wind turbine, a crane is erected at the maintenance/construction site. The crane needs to have a vertical extension which is greater than the height of the wind turbine tower in order to be able to lift components to the top of the wind turbine tower. As wind turbines and wind turbine towers continue to grow in size, the cranes need to be larger and larger. This is a problem both when transporting the crane to the maintenance/construction site and when setting up the crane. This is true both in onshore and offshore locations. In onshore locations, it can be difficult to move a crane between wind turbines and then create a stable foundation. For example when the terrain around the wind turbines is rocky, mountainous, forest, etc. In offshore locations, a foundation to the seabed is typically necessary to establish a stable foundation for the crane which in many cases requires a large jackup rig.

In other cases, a crane can be hoisted to the top of the wind turbine tower with a block and tackle and then clamped to the tower itself via bands or arms which clamp onto or wrap around the tower. In order to be able to support the forces and moments which the crane experiences during lifting operations, multiple bands or arms are required. Typically, the arms are separated by a vertical distance on the tower. When forming the bands or arms, it is important that the bands or arms don't damage the tower structure when clamping onto the tower and when using the crane.

It is also known to attach a crane to a tower via a track system which extends up along one side of the wind turbine tower. This system is disclosed in WO2017/055598. In this case, the crane can also be used to assemble the tower itself and “climb” the tower as the tower is built.

From another type of tower (non-wind turbine) it is known to provide each tower section with multiple vertically spaced brackets on the side surface of each tower section. A crane can then be attached to these brackets via multiple vertically spaced arms on the crane. See U.S. Pat. No. 2,720,694.

However, the prior art solutions all suffer from various drawbacks. Some of the systems are relatively complex. Other systems require a large crane structure.

Other systems require an existing tower and a connection to the top of the tower to be able to hoist the crane into place. Other systems require complicated brackets attached to the surface of the tower sections which require significant modifications of existing tower section designs.

### Overview of the Invention

At least one invention disclosed in this specification relates to a wind turbine mounted crane configured to facilitate an installation, a maintenance and/or a repair of a wind turbine, the crane comprising:
a base portion,
a wind turbine connection mechanism connected to the base portion and configured to engage with a wind turbine and arranged such that the base portion is supported by the wind turbine when the wind turbine connection mechanism of the crane is engaged with the wind turbine,
a boom rotatably connected to the base portion both about a vertical axis passing through the base portion and about a horizontal axis passing through the base portion,
a lifting hook for lifting a load,
at least one lifting wire, the lifting wire running through the base portion and along the boom and being connected to the lifting hook, and
at least one winch connected to the at least one lifting wire, the winch and lifting wire being arranged such that when the at least one winch is rotated, the lifting hook moves up or down.

According to this specification, the term “wind turbine mounted crane” should be understood as a crane which is connected or connectable to a wind turbine, such that the crane is or can be supported by the wind turbine itself. In certain embodiments, the wind turbine mounted crane is connected to the tower of the wind turbine, at a location somewhere below the nacelle of the wind turbine. These types of cranes could also be called a tower mounted cranes or wind turbine tower mounted cranes, but are still considered wind turbine mounted cranes for the sake of this specification. In other embodiments, the wind turbine mounted crane could be connected to the nacelle of the wind turbine or to a fixture arranged in the nacelle of the wind turbine. This is sometimes called a nacelle mounted crane or an up tower crane, but are also considered wind turbine mounted cranes according to this specification. It should also be noted, that the term “wind turbine mounted crane” suggests that the crane is mounted to a wind turbine. However, the scope of protection should cover the crane itself, as the term is used to define that the crane is of the kind which is able to be mounted to a wind turbine, not necessarily that the crane is mounted to a wind turbine.

The term “wind turbine mounted crane” is used to differentiate from a “free standing crane” which is located separate from the wind turbine tower, for example a crane which is arranged on the ground next to the wind turbine or floating next to a wind turbine tower on a barge or other floating vessel in an offshore application. In this specification the term “free standing crane” is used to describe cranes which are not wind turbine mounted cranes. Free standing cranes are sometimes assembled on a crane base foundation arranged on the ground, for example a concrete foundation built on/in the ground. Other examples of free standing cranes are cranes which are driven or sailed to the wind turbine location.

Also, according to this specification, the term “wind turbine connection mechanism” should be understood as a system of components which allow the crane to be connected/attached to a wind turbine. The different inventions disclosed in this specification are for the most part, not dependent on the specific form of the connection between the wind turbine and the crane, hence, the connection mechanism is not specified in detail in the claims. Some specific details of one wind turbine connection mechanism are disclosed and described in detail in applicant's co-pending application filed with the Danish patent and trademark office on 24.04.2023 with the title “CRANE WITH TOWER CONNECTION MECHANISM”. Said application is incorporated by reference in its entirety. It should be noted that in the specific embodiments disclosed in the current specification, the wind turbine connection mechanism is arranged to connect the crane to a flange on a tower section. However, the term wind turbine connection mechanism according to the current specification should also be understood as including a mechanism which can allow a crane to connect to a nacelle of a wind turbine, to a fixture arranged in a nacelle of a wind turbine or to a tower section via some other form of connection mechanism, for example multiple arms, bands, etc.

One prior art crane which is different from the one shown in the figures of this specification, has a tower connection mechanism in the form of two horizontally arranged belts being vertically spaced from each other and wrapping around the surface of a tower section. The belts are tightened around the tower to fix the crane with respect to the tower. In another prior art type crane, see WO2017/055598, a set of vertically arranged rails are provided on the tower and a tower connection mechanism of the crane connects to the vertically arranged rails.

It should also be noted that according to this specification, the term “wire” is used to broadly represent an elongated flexible member. Typically, braided steel wires are used in crane lifting operations, but other forms of elongated flexible members can also be used, for example ropes, cables, etc. The material of the elongated flexible members could be made from many suitable materials as will be known to the person skilled in the art. In many situations, steel is used, but other options, for example fiber based ropes could also be used. The term “wire” should therefore be understood broadly.

It should also be noted that the winch of the crane could be located on the crane itself, or at another location remote from the crane. For example, in certain cases, such as the one shown in the figures of this application, the main lifting winches for the crane are provided on the ground. In other embodiments (not shown), the main lifting winch/winches is/are located on the base portion of the crane or on the boom itself. The location of the winch should therefore not be limited according to this specification. In this respect, the term “wind turbine mounted crane” should be interpreted broadly, and not limited to the mechanical components which are physically mounted on the wind turbine tower, but should include components which are necessary for the crane to function. For example, in the claims it is stated that the “crane” comprises at least one winch. This should not be interpreted in that the winch is necessarily mounted on the crane itself, but it could be located on the ground, on a platform connected to the tower, on a ship sailing next to the tower, on the base portion of the crane, on the boom of the crane, etc. . . . . In other words, the crane could comprise a winch mounted on the ground, or on the tower.

According to this specification, the term sheave should be understood as a single cylindrical body with a groove for the wire to lay in and with a bearing interfacing to a shaft that is connected to one of the crane embodiments.

The term drum should be understood as a cylindrical body with several grooves for the wire to lay in. Some drums have helical grooves such that the same wire may wrap multiple times around the drum, while other drums have a number of parallel grooves, similar to a plurality of sheaves mounted side by side.

The term pulley should be understood as an assembly of a sheave with a shaft and often a support body of some sort. A pulley and a drum is not the same type of component. A pulley can consist of several sheaves. A drum is one part with several grooves. A drum can often be replaced by a number of parallel sheaves, or a number of parallel sheaves can often be replaced by a drum.

The current specification also discloses additional inventions related to hoist blocks used together with a crane as discussed above, to a crane system comprising a crane and a hoist block and to methods of lifting components.

### SUMMARY OF THE FIRST INVENTION

The first invention relates to a mechanism for wire routing of a lifting wire to allow rotation of a boom with respect to the location of a winch which is controlling the tension in the wire. In some wind turbine mounted cranes, one or more lifting wires are controlled by one or more ground based winches. In this way, the lifting wire runs from the ground based winch, to the base portion of the wind turbine mounted crane and then through the base portion to the crane boom and then further to the tip of the boom and then to the lifting hook. In order to allow the crane boom to rotate about a vertical axis, the lifting wire needs to be routed through the base portion of the crane without twisting. This is especially important when two lifting wires are used. In certain cases, one could also consider a case where winches contributing to the tension in the wires are mounted to a portion of the crane which does not move together with the boom.

One example of a prior art system is disclosed in applicant's own application published as WO2014071949. The mechanism allows slew motion of the boom between around 170 degrees in one direction and 170 degrees in the other direction. There is a therefore a small dead zone between the two extremes which the crane cannot reach. Furthermore, if the crane wants to go from a position of −160 degrees to +160 degrees, the crane is forced to rotate from −160 to +160 around the 0 position, i.e. the crane is forced to travel 320 degrees. It would be more interesting if the crane could move from −160 to +160 via the 180 degree position, i.e. a motion of just 40 degrees. Furthermore, the known mechanism twists the wire about a longitudinal axis of the wire when the boom rotates which affects the longevity of the wire in a negative way.

A first aspect of the first invention is therefore to provide a mechanism to allow a more flexible crane operation by providing a greater range of slew motion of the boom about a vertical axis.

A second aspect of the first invention is to provide a mechanism which reduces rotation of the wire about a longitudinal axis of the wire.

These aspects are provided at least in part according to a crane as disclosed in claim 1. In this way, the wire can be wrapped up around the at least two pulleys and allows a motion of greater than 180 degrees in both directions. In the embodiment shown in the figures, a range of motion of around 300 degrees in both directions is provided, completely eliminating the dead spot and providing a much larger flexibility. Furthermore, the mechanism does not twist the wire about its longitudinal axis, thereby providing for a longer lifetime.

In some embodiments, the boom is configured to rotate about the vertical axis relative to the base portion by more than 220 degrees, more than 250 degrees or more than 280 degrees from an initial position in a first direction and/or more than 220 degrees, more than 250 degrees or more than 280 degrees from the initial position in a second direction opposite to the first direction.

In some embodiments, the crane further comprises a slew pulley assembly to route the first and second lifting wires from the base portion to the lifting block. The slew pulley assembly comprising a first pulley arrangement attached to the base portion in such a way that it rotates with the boom arm around the vertical axis and comprising at least two first sheaves arranged in a first horizontal plane and rotating around parallel axes. The slew assembly also comprising a second pulley arrangement attached to the base portion in such a way that it rotates with the boom arm around the vertical axis and comprising at least two second sheaves arranged in a second horizontal plane and arranged to rotate about parallel axes. The slew assembly also comprising a first vertical sheave associated with the at least two first sheaves and configured to route the first lifting wire towards the lifting hook, and a second vertical sheave associated with the at least two second sheaves and configured to route the second lifting wire towards the lifting hook. Moreover, the slew assembly comprising a first base portion sheave attached to the base portion in such a way that it does not rotate with the boom, and a second base portion sheave attached to the base portion in such a way that it does not rotate with the boom. The first lifting wire is routed from the first base portion sheave on the base portion to the first vertical sheave through one or more of the first sheaves of the first pulley arrangement and the second lifting wire is routed from the second base portion sheave to the second vertical sheave through one or more of the second sheaves of the second pulley arrangement.

In some embodiments, the base portion comprises a main crane body and a slew platform, the wind turbine connection mechanism being attached to the main crane body, the slew platform being arranged pivotably on the main crane body, and the first and second pulley arrangements being attached to the slew platform.

In some embodiments, the first horizontal plane is arranged above the second horizontal plane. When the first pulley arrangement and the second pulley arrangement are located on different planes, the two lifting wires can be easily routed independently of each other.

In some embodiments, the at least two first sheaves and the at least two second sheaves are arrayed around the axis of rotation of the first and/or second pulley arrangement.

In some embodiments, the at least two first sheaves comprise three or four sheaves and the at least two second sheaves comprise three or four sheaves. In some embodiments, the three or four sheaves are arrayed around the axis of rotation of the first and/or the second pulley arrangement.

In some embodiments, the first base portion sheave is arranged in the same plane as the sheaves of the first pulley arrangement and the second base portion sheave is arranged in the same plane as the sheaves of the second pulley arrangement.

In some embodiments, the first pulley arrangement and the second pulley arrangement are arranged between the first base portion sheave and the second base portion sheave.

In some embodiments, the first pulley arrangement and the first base portion sheave are arranged as a mirror image of the second pulley arrangement and the second base portion sheave.

In some embodiments, the crane further comprises a compensation arrangement which compensates for the lifting wire being wrapped up on or off of the first and second pulley mechanisms when the boom arm rotates.

In some embodiments, the compensation arrangement comprises a sensor which detects the rotation of the boom arm and a controller which controls the at least one winch to either retract or extend the first and/or second lifting wire when the boom arm rotates.

In some embodiments, the compensation mechanism may be arranged in the hook assembly, where the first and/or second lifting wires are compensated differently. In some embodiments, the hook assembly comprises lifting wire displacement mechanisms where a distance between a sheave routing the first lifting wire in the hook assembly and the hook and a distance between a sheave routing the second lifting wire in the hook assembly and the hook can be adjusted separately.

In some embodiments, the compensation mechanism includes an actuator configured to make the first and/or the second lifting wire longer or shorter. For example, the crane may include a single drum on which the first and the second lifting wires are wrapped, and two pulleys separated by a linear actuator which can change length and the first or the second wires being wrapped around the two pulleys. As the linear actuator changes length, the length of the lifting wire will change.

### SUMMARY OF THE SECOND INVENTION

The second invention relates to mechanism for controlling the lifting wires of the crane whereby the position of the crane relative to the tower can be controlled.

In prior art type systems, such as the one described in applicants co-pending application WO2020201237A2, the crane just needs to be lifted from the ground to the top of the tower. However, when moving the crane up along the tower while the tower is being built, more precise control of the crane position is needed.

It is therefore a first aspect of the current invention to provide a wire control mechanism to allow positioning the crane relative to the tower more precisely during the lifting operation.

This is provided by a crane system as defined by example 1 below. According to this invention, it is possible to differentiate between the tension in the wire running from the crane to hoist block and the tension in the wire running from the crane to the ground based winch when lifting the crane. This allows the position of the crane relative to the tower to be controlled during the crane lifting operation. For example, when the wire tension in the wire running from the crane to the ground is increased, the crane will move away from the tower. When the wire tension in the wire running from the crane to the ground is decreased, then the crane will move towards the tower.

In some embodiments, the traction winch also contributes to the tension in the third portion of the lifting wire such that the tension in the second and third portions are the same.

In some embodiments, the crane system comprises two lifting wires and the crane comprises two traction winches, a first traction winch being associated with a first lifting wire and a second traction winch being associated with a second lifting wire.

In some embodiments, a portion of the second portion and/or the third portion of the first lifting wire is arranged on a first side of a vertical plane passing through the centre of the base portion and a portion of the second portion and/or the third portion of the second lifting wire is arranged on a second side of the vertical plane passing through the centre of the base portion. In this way, the position of the crane relative to the tower can also be controlled about a vertical axis.

In some embodiments, the first traction winch is arranged on a first side of a vertical plane passing through the centre of the base portion and the second traction winch is disposed on a second side of the vertical plane passing through the centre of the base portion.

In some embodiments, both the first and the second traction winch are arranged on the same side of the vertical plane.

In some embodiments, the crane system comprises two ground based winches. In some embodiments, a first ground based winch is associated with a first lifting wire and a second ground based winch is associated with a second lifting wire.

In some embodiments, the two traction winches are controlled to differentially control tension in first wire portions of the two lifting wires to rotate/twist the crane about a vertical axis passing through a centre of the base portion. In this way, a tower connection mechanism of the crane can be better aligned with the tower of the wind turbine.

In some embodiments, the traction winch comprises a motor and a drum and a clutch arranged between the motor and the drum to selectively disengage the drum from the motor when the tension in first and second portions of the lifting wire is to be kept same.

In some embodiments, the traction winch may be rotated in synchronization with an associated ground based winch to eliminate the need of decoupling a drum of the traction winch from associated motor during lifting and lowering of the load by the crane or when the tension in first and second portions of the lifting wire is same. Accordingly, the clutch mechanism may be omitted.

In some embodiments, the ground based winch is a traction winch and in that the system further comprises a drum to roll up the free end of the lifting wire.

In some embodiments, the ground based winch is a drum based winch which applies tension to the lifting wire as the lifting wire is rolled up on the drum.

In some embodiments, in one mode of operation of the crane, the at least one traction winch is arranged to operate as a generator to charge a battery located on the crane.

In some embodiments, the at least one traction winch is operated as a generator during lowering or lifting of a load by the crane.

In the embodiment shown in the figures, the crane has two traction winches. As mentioned above, these traction winches could, in some embodiments, be used as generators to charge batteries or otherwise provide power. However, it should be noted that the idea of using a winch as a generator, can also be used in crane systems where there is no specific need for a traction winch. A pulley can be provided at any position where it can be driven by a wire and then the pulley can be connected to a generator to generate power. This can be relevant at locations where a battery needs to be charged but where it is difficult to get power to the battery to recharge it.

Also, other types of traction winches can also make use of this idea. One example is a pulley which is placed at the tip of the boom which is in contact with the lifting wire which goes from the tip of the boom to the lifting hook. In certain cases, a motor is provided at the tip of the boom to drive the pulley to actively pull the wire. This is sometimes required when the lifting hook itself is not heavy enough to pull the wire out by itself. This type of mechanism is described in more detail in applicant's co-pending application WO2022/234140 which is incorporated by reference in its entirety. In this type of mechanism, it could be relevant to provide for the option of operating the motor as a generator to charge a battery which is usually used to power this motor.

### SUMMARY OF THE THIRD INVENTION

The third invention relates to preventing the crane from rotating about the lifting wires when lifting the crane up to the tower. If the crane were to rotate about the lifting wires during the lifting operation, the crane would wrap around the lifting wires, completely blocking any further motion of the claim.

Especially during windy sessions and/or in rain/snow/icy conditions, the loading on the crane can be quite significant and it is therefore necessary to ensure that the crane remains stable while being lifted.

It is therefore a first aspect of the third invention to provide a wire control mechanism which ensures that the COG of the crane remains below the lifting wire during the lifting operation.

This is provided by a crane system according to example 10 below. By displacing the position of the main crane lifting pulley block, a position of centre of gravity (COG) of the crane relative to an axis of rotation of the crane system during lifting of the crane is controlled.

In some embodiments, during the lifting of the crane along the tower, the position of the main crane lifting pulley block is controlled such that the COG of the crane is maintained below the axis of rotation to prevent a rotation of the crane about the axis of rotation. In some embodiments, it is desired to keep the distance between the COG and the axis of rotation as large as possible.

In some embodiments, to keep the COG of the crane below the axis of rotation, the main crane lifting pulley block is displaced/moved to a raised position during the lifting of the crane and then displaced/moved to a lower position when the crane is to be attached to the tower. By moving the main crane lifting pulley block downwardly, room is made for the hoist block.

In some embodiments, the displacement mechanism comprises a beam pivotably connected to the base portion and where the main crane lifting pulley block is connected to a portion of the beam.

In some embodiments, the beam is arranged to pivot about a horizontal axis.

In some embodiments, the crane further comprises a linear hydraulic cylinder connected between the beam and the base portion and where the linear hydraulic cylinder is arranged to pivot the beam when the linear hydraulic cylinder extends or retracts.

In some embodiments, the main crane lifting pulley block is a first main crane lifting pulley block and the crane further comprises a second main crane lifting pulley block and a second lifting wire, said second main crane lifting pulley block being arranged parallel to the first main crane lifting pulley block and a first portion of the second lifting wire being arranged to go from the winch or from a second winch to the second main crane lifting pulley block, a second portion of the second lifting wire being arranged to go from the second main crane lifting pulley block to the hoist pulley block and a third portion of the second lifting wire being arranged to go from the hoist pulley block to the second main crane lifting pulley block, and wherein the crane further comprises a second displacement mechanism for displacing the horizontal and/or vertical position of the second main crane lifting pulley block relative to the base portion of the crane.

In some embodiments, the at least one hoist pulley block comprises a first hoist pulley block and a second hoist pulley block, the first lifting wire being arranged over the first hoist pulley block and the second lifting wire being arranged over the second hoist pulley block.

In some embodiments, the winch is a ground based winch.

### SUMMARY OF THE FOURTH INVENTION

The fourth invention relates to the problem of getting the hoist block down from the top of the tower at the end of the lifting procedure. Due to the weight of the block and the wires connected to the block, a large light-weight crane is required to lower the block and wires down.

It is therefore a first aspect of the fourth invention to provide a hoist block which can be lowered by a smaller light-weight crane.

This is provided by a hoist block according to example 20 below. Accordingly, the hoist block includes at least one hoist pulley block that can be removed from the frame portion and the least one hoist pulley block and the frame portion are lowered independently each other using a small crane.

In some embodiments, the retention structure and the coupler are arranged such that the hoist pulley block can be disengaged from the retention structure by moving the hoist pulley block relative to the frame with a motion having a direction with a vertical component.

Accordingly, to remove the hoist pulley block from the frame portion while the hoist block is disposed at top of the tower of the wind turbine, the hoist pulley block is simply moved vertically upwardly relative to the frame portion. This form of motion is easy to achieve with a light weight crane.

A vertical lift combined with later horizontal move away from hoist block, ensures a strong connection during the actual lifting operations by the main crane while being easy to split apart without any mechanical “locking” mechanisms being necessary.

In some embodiments, the motion has a direction which forms an angle of less than 45 degrees to a vertical axis. In some embodiments, during lowering of the hoist pulley block which is engaged with the lifting wire, the ground based winch is operated in synchronization with the light weight crane.

In some embodiments, the at least one hoist pulley block is one of at least two hoist pulley blocks, and the retention structure is one of two retention structures in the frame portion separated by a horizontal distance and wherein each of the two hoist pulley blocks being independently disengageable from the frame portion by motion in a vertical direction.

In this manner, to lower the hoist block, each of the two hoist pulley blocks is disengaged from the frame portion one by one and lowered to the ground. Thereafter, the frame portion is disengaged from the wind turbine tower and lowered to the ground using a wind turbine mounted light weight crane.

In some embodiments, the frame portion comprises a horizontal beam and a column structure. The horizontal beam is arranged near the upper end of the vertical beam.

In some embodiments, the frame portion includes a T shaped configuration.

In some embodiments, the horizontal beam comprises the two retention structures and the two retention structures are two “seats” to support the two hoist pulley blocks at a horizontal distance apart from each other.

In some embodiments, a lower portion of the column structure comprises pads adapted to abut an outer surface of the tower when the hoist block is engaged with the tower section. In some embodiments, an upper portion of the frame portion comprises a tower connection element which is arranged to engage with a portion of a tower to support the hoist block on the tower.

In some embodiments, each of said two hoist pulley blocks comprises at least two separate pulley blocks which can be removed from said retention structures independently of each other.

In some embodiments, a first of said at least two separate pulley blocks of one hoist pulley block is connected to a first of said at least two separate pulley blocks of another hoist pulley block such that the connected separate pulley blocks can be lifted simultaneously. It should be noted that during normal use of the crane, the lifting wires will be exposed to tension while they are running past the different sheaves of the different pulleys. Over time, the wires will acquire a form of rotational twist bias which will cause the wires to twist when tension is removed. When the hoist pulley block is lifted out of the hoist block, the tension is removed and there is a risk that the wire will start to twist. By lifting a portion of the hoist pulley block from the right of the hoist block and a portion of the hoist pulley block from the left of the hoist block, twisting is prevented as the wire from the left side will want to twist in the opposite direction to the wire from the right side.

### SUMMARY OF THE FIFTH INVENTION

The fifth invention relates to connecting a hoist block to a tower.

It is a first aspect of the fifth invention to provide a connection between a hoist block and a tower which is easy to engage and disengage.

It is a second aspect of the fifth invention to provide a connection between a hoist block and a tower which reduces the loads on a flange of a tower as much as possible.

This is provided by a hoist block according to example 30 below.

In some embodiments, the hoist block connection element includes an elongated recess and the vertically downwardly extending protrusion extends inside the recess when the hoist block is engaged with a tower.

In some embodiments, the flange comprises two elongated recesses and the hoist block comprises two elongated protrusions. The two elongated recesses and the two protrusions being arranged spaced apart from each other by a horizontal distance.

In some embodiments, the two protrusions are arranged at an angle to each other. In this way, the protrusions can be arranged closer to the outer surface of a curved surface of a tower. This will reduce the bending moments on the tower. In some embodiments, the angle between the two protrusions is greater than 140 degrees, greater than 150 degrees or greater than 160 degrees.

In some embodiments, the two protrusions are arranged pivotably with respect to the frame such that the angle between the two protrusions in the horizontal plane can be adjusted.

In some embodiments, the hoist block includes at least one guide structure extending vertically downwardly of the at least one wind turbine connection element to guide an insertion of the at least one protrusion inside the at least one recess during the vertical downward movement of the hoist block.

The fifth invention also relates to a wind turbine tower comprising a horizontal flange extending out from the tower, and a hoist block as described above is engaged with the flange.

In some embodiments, the wind turbine tower comprises a second flange which is bolted to the horizontal flange of the tower and in that the second flange comprises at least one recess which cooperates with the protrusion of the hoist block. In this manner, tower sections having a horizontal flange can be adapted to be used with the abovementioned hoist block by bolting an additional flange having at least one recess to the tower. In some embodiments, the second flange is attached to a flange of the wind turbine tower section which is used to connect the wind turbine tower section to another wind turbine tower section.

### SUMMARY OF SIXTH INVENTION

The sixth invention relates to providing a wind turbine mounted crane which can be put both in a stable position during lifting and be able to work in the necessary positions during the actual component lifting actions after it has been attached to the wind turbine.

A first aspect of the sixth invention is to provide a crane which is stable during lifting.

A second aspect of the sixth invention is to provide a crane which can perform many different actions and provide flexibility in its operations.

A third aspect of the sixth invention is to provide a crane which is easy to adjust.

These aspects are provided by a wind turbine mounted crane according to example 40 below. In this way, a crane is provided which can be arranged in a stable position while being lifted into position and then also be able to achieve different positions which are needed during the lifting operations performed by the crane.

In some embodiments, the boom arm is connected to the base portion via an intermediate raise mechanism and a slew platform where the lower portion of the boom arm is pivotably connected to the intermediate raise mechanism about a first horizontal axis and in that the intermediate raise mechanism is pivotably connected to the slew platform about a second horizontal axis. By having the intermediate raise mechanism between the boom arm and the base portion, the boom arm is able to be pivoted by more than 150 degrees between the vertically upward position and the vertically downward position in a simple manner.

In some embodiments, the first and second horizontal axes are arranged parallel to each other. In some embodiments, the first and second horizontal axes are arranged co-axial.

In some embodiments, the slew platform and the intermediate raise mechanism are connected together via a first hydraulic actuator which is arranged to change an angle between the slew platform and the intermediate raise mechanism. Further, the intermediate raise mechanism and the boom arm are connected together via a second hydraulic actuator which is arranged to change an angle between the intermediate raise mechanism and the boom arm.

In some embodiments, the slew platform is rotatably connected to the base portion about a vertical axis.

In some embodiments, the crane is arranged to have a first position where the boom arm is pivoted downwardly at an angle of greater than 80 degrees, a second position where the boom arm is pivoted upwardly at an angle of greater than 80 degrees and a third position where the boom arm is pivoted further at least 120 degrees.

### SUMMARY OF THE SEVENTH INVENTION

The seventh invention relates to a crane system whereby the loads applied by the crane to a tower section can be reduced when lifting heavy wind turbine components.

This is provided by a crane system according to example 50 below. In this way, the forces generated by the load being lifted are distributed between the hoist block and the crane, such that the loads applied by the crane to the tower section are reduced. In the examples shown in the figures, instead of having four crane connection points, the loads are spread out between the four crane connection points and the hoist block.

In some embodiments, the wind turbine connection mechanism of the crane is arranged to releasably connect to a flange on a tower of the wind turbine and in that the wind turbine connection element of the hoist block is arranged to releasably connect to a flange on a tower of the wind turbine.

In some embodiments, the wind turbine connection mechanism of the crane comprises at least three flange connection elements spaced apart from each other for releasably connecting the crane with a flange on a tower of a wind turbine.

In some embodiments, the wind turbine connection mechanism of the crane is arranged to be releasably attached to a flange on a tower of a wind turbine and in that the wind turbine connection element of the hoist block is arranged to be releasably attached to the same flange on a tower of a wind turbine at the same time as the wind turbine connection mechanism of the crane is also releasably attached to the flange of the tower of the wind turbine. In this way, a single flange can be provided on the tower section to which both the crane and the hoist block can be connected. In some embodiments, the flange is formed as an integral component of a flange of a tower section which is arranged to be connected to another flange on an adjacent tower section. In some embodiments, the flange is located near the top of a tower section. In some embodiments, the flange on the tower section to which the crane and hoist block are to be connected is located at a distance from the uppermost flange of the tower section.

The invention also relates to a wind turbine tower comprising a flange extending outwardly from the outer surface of the tower and a crane system as described above connected to the wind turbine tower, where the crane is releasably attached to the flange and the hoist block is releasably attached to the flange and a wind turbine tower section, a wind turbine nacelle, a wind turbine hub or a wind turbine blade is connected to the lifting hook of the crane.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 shows a perspective view of a step in a process of building a wind turbine tower with a self-climbing crane, where a hoist block is lifted into place on the lowermost tower section using a smaller mobile crane.

FIG. 2 shows a perspective view of another step where the crane is lifted free of the ground.

FIG. 3 shows a perspective view of the crane halfway up the tower section with a tip of the boom arranged below a base portion of the crane.

FIG. 4 shows a perspective view of the crane arranged near a flange at the top of the tower section with the boom still arranged in a vertically downward position.

FIG. 5 shows a perspective view of the crane clamped onto the flange with the boom still arranged in the vertically downward position.

FIG. 6 shows a perspective view of the crane supported on the tower section and the boom rotated into a normal lifting position.

FIG. 7 shows a perspective view of the crane lifting a second tower section to position the second tower section on top of the first tower section.

FIG. 8 shows a perspective view of the second tower section engaged to the first tower section and the lifting hook of the crane connecting to the hoist block.

FIG. 9 shows a perspective view of the crane lifting the hoist block to the top of the second tower section where it can be connected to a flange at the top of the second tower section.

FIG. 10 shows a perspective view of the boom moved to the vertically downwardly position to prepare for the next crane displacement step.

FIG. 11 shows a perspective view of the arms of the crane unclamped from the flange to free the crane from the first tower section and enable the next crane displacement.

FIG. 12 shows a perspective view of the crane lifted to the top of the second tower section but not yet engaged with a flange at the top of the second tower section.

FIG. 13 shows a perspective view of the crane ready to lift additional components to the top of the tower with boom arranged in the lifting position and the crane engaged with the flange of the second tower section.

FIG. 14 shows a perspective view of the crane lifting the nacelle into position.

FIG. 15 shows a perspective view of the crane lifting a blade so that it can be connected to the hub.

FIG. 16 shows a perspective view of the crane boom arranged in the vertically downward position in preparation for lowering the crane to the ground.

FIG. 17 shows a perspective view of the crane lowered almost to the ground.

FIG. 18 shows a perspective view of the hoist block being lowered by a small lightweight crane arranged in the nacelle.

FIG. 19 shows a detailed view of a wire pulley section from a side of the crane with the boom extending downwardly of the base portion of the crane.

FIG. 20 shows another detailed view of the same arrangement as FIG. 19, but from another angle.

FIG. 21 shows another detailed view of the same arrangement as FIG. 19, but from a different angle and with some more components removed, so that the details of the wire guide system inside the base portion are shown.

FIG. 22 shows a side view of the crane showing details of the wire pulley system with some of the components of the crane removed to show the details of the wire pulley system.

FIG. 23 shows a side view similar to FIG. 22 but with the boom in a different position showing the effect on the COG of the crane when the boom changes position.

FIG. 24 shows another side view as FIG. 22 with the boom in a different position and the main crane lifting pulley block arranged in lowered position.

FIGS. 25 and 26 show two side views showing different positions of the crane with respect to the tower.

FIG. 27 shows a top view showing a method of positioning the crane with respect to the tower.

FIG. 28 shows a detailed perspective view of a pulley block assembly arranged inside the base portion of the crane to allow angular motion of the boom about a vertical axis.

FIG. 29 shows an exploded perspective view of the pulley block assembly of FIG. 28.

FIGS. 30-33 show different schematic illustrations of the pulley block assembly depicting the routing of the lifting wires in different degrees of rotation of the boom.

FIG. 34 shows a front perspective view of one embodiment of a hoist block.

FIG. 35 shows a partial exploded perspective view of the hoist block of FIG. 34.

FIG. 36 shows a detailed perspective view of a portion of the hoist block connected to a flange mounted on a tower section but with the tower hidden.

FIG. 37 shows a view similar to FIG. 36, but where the hoist block has been disengaged with the flange mounted on the tower section.

### DETAILED DESCRIPTION OF THE EMBODIMENTS

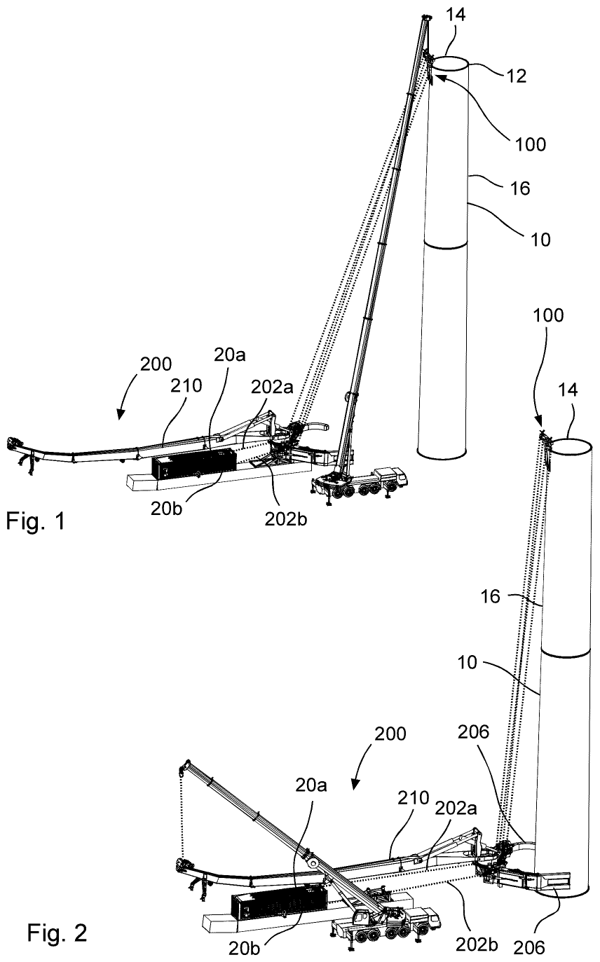

FIGS. 1 to 18 show various steps of a method for assembling a wind turbine, where the tower is built first, then the nacelle is placed on the top of the tower and then the blades are connected to the rotor hub. The method used in the figures makes use of a novel type of crane and a tower section with a novel flange to enable the assembly method. The novel crane and flange are described in more detail in applicant's co-pending application filed on 24 Apr. 2023 with the Danish Patent and Trademark Office and having the title “CRANE WITH TOWER CONNECTION MECHANISM”.

While the figures show details of the crane and the flange, the principles described in the application will for the most part also work on other cranes, not necessarily the same as the one shown in the figures. For example, the wire routing mechanism, details of the hoist block, etc., could also be used with a crane having a different form of connection to the tower than the one shown in the figures unless specifically mentioned. The above-mentioned application describes some examples of other types of cranes.

The function of the crane will be described with reference to the method steps described below to better illustrate the function.

In FIG. 1, a base tower section 10 has been erected on a supporting surface (not shown), in a manner which is known in the art. In certain cases, a smaller mobile crane can be used to erect the base tower section 10. The base tower section 10 is typically bolted to a foundation element (not shown) as is known in the art.

Once the base tower section 10 is erected, a hoist block 100 is lifted up to the top of the base tower section 10 and connected to the top of the base tower section 10 via a bracket 11 mounted to a flange 12 arranged proximate to a top end 14 of the base tower section 10 and extending circularly around a central axis of the base tower section 10. Moreover, the flange 12 extends radially outwardly of an outer surface 16 of the base tower section 10. The bracket 11 (shown in FIG. 37) has an L-shaped cross section and includes hoist block connection elements, for example, a recess 18 (shown in FIG. 37), extending into the top surface of the bracket 11 to receive or engage with tower connection elements of the hoist block 100. This type of engagement is described in more detail later on in this specification with respect to FIGS. 34-37. In the current embodiment, the bracket 11 is bolted to the flange 12 of the tower section 10. In another embodiment, the bracket could be made integral to the flange of the tower section 10, while in alternate embodiments, the bracket 11 may be welded to the flange of the tower section.

After connecting the hoist block 100 with the base tower section 10, two ground winches 20a, 20b are operated to move the crane 200 towards the top end 14 of the base tower section 10 as described in more detail below. Although two ground winches 20a, 20b are used in the current embodiment, it may be envisioned that a single ground winch or more than two ground winches may also be used. It may be appreciated that a number of the ground winches may depend on a number of lifting wires of the crane 200. In the current embodiment, the two wires are controlled by two separate traction winches located on the ground. The free ends of the lifting wires, after passing through the traction winches are rolled up onto storage drums. In this embodiment, the tension and motion of the two lifting wires can be controlled independently. In other embodiments (not shown), a single drum could be provided onto which both lifting wires are wound. In this case, the tension in and motion of the two wires cannot be controlled independently.

The ground winches 20a, 20b are located on the ground and two separate lifting wires 202a, 202b extend from the winches 20a, 20b to a base portion 206 of the crane 200, then from the crane 200 to the hoist block 100 and then from the hoist block 100 back to the crane 200 where the wires 202a, 202b are fastened. The lifting wire routing is described in more detail later on in this specification with respect to FIGS. 18-24. As the ground winches 20a, 20b are operated and the wires 202a, 200b wound up on the ground based winches 20a, 20b, the crane 200 is lifted from the ground, and moves towards the base tower section 10 in the horizontal direction as well as upwardly in the vertical direction. In this embodiment, a mobile crane is used to help lift the crane 200 free of the trailer on which it is arranged. In other cases, the design of the crane and/or the trailer can be adjusted such that a mobile crane is not required to lift the crane 200 free of the trailer.

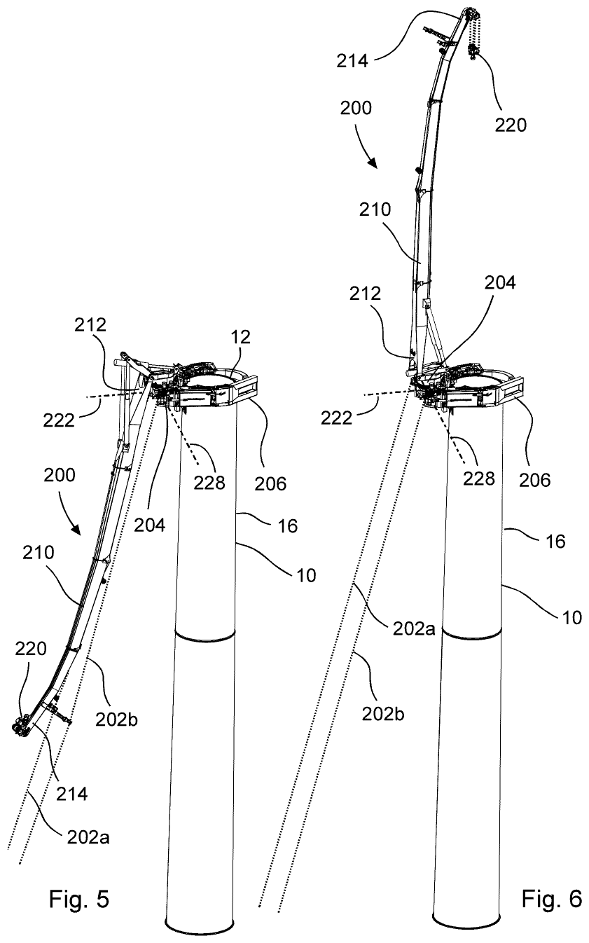

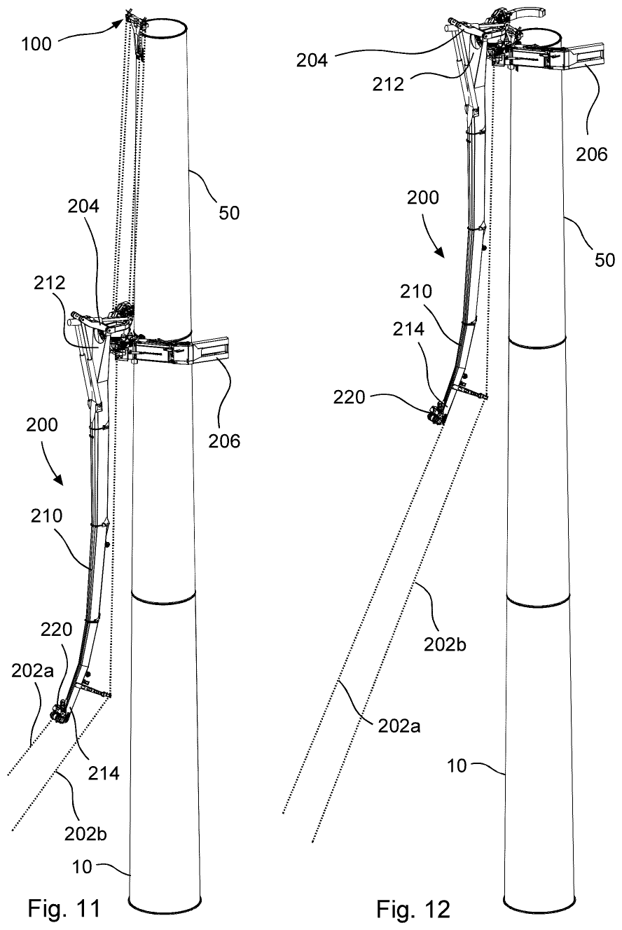

In this embodiment, the crane 200 comprises a base portion 204 and two arms 206 pivotably connected to the base portion 204. The two arms 206 are arranged to pivot around vertical axes so that they can be pivoted into connection with a tower section, as shown in FIGS. 5 and 6, or pivoted away from the tower section, as shown in FIGS. 11 and 12, to release the crane 200 from the tower section. The arms 206 are provided with jaws which engage with the flange of the tower section. As mentioned above, the details of the jaws and the flange are not discussed in the specification as the inventions claimed in this application are not dependent on the type of connection between the tower and the crane.

In this embodiment, the base portion 204 and the arms 206 of the crane 200 are arranged such that when both arms 206 are connected to the tower section 10, then the base portion 204 can absorb a large moment in a safe manner and without undue deflection. Hence, the entire load of the crane 200 can be supported by the arms 206 and the base portion 204. As will be discussed later on with respect to invention seven, in the current embodiment, some of the load can, during some lifting operations, be transferred to the tower section by a combination of the arms of the crane and the hoist block. The term “large moment” should be related to the crane size and the maximum amount that the crane is designed to lift. Larger cranes which can lift larger tower sections will have to have stronger arms and the towers will need to have stronger flanges. Smaller cranes which lift smaller tower sections can be made with less strong arms and the towers can be made with less strong flanges.

The crane 200 further comprises a boom 210 including a lower portion 212 pivotally connected to the base portion 204 and a tip portion 214 arranged distally from the base portion 204. The crane 200 also includes a lifting hook 220 displaceably connected to the tip portion 214 and configured to facilitate a lifting of a load by the crane 200. The boom 210 is arranged to be able to tilt/pivot relative to the base portion 204 between a vertically downward position (shown in FIG. 5) and a vertically upward position (shown in FIG. 6). In the vertically downward position (FIG. 5), the tip portion 214 is arranged below the base portion 204 and a vector connecting a lower end of the lower portion 212 of the boom 210 and an outer end of the tip portion 214 of the boom 210 forms an angle, in a vertical plane, of more than 80 degrees relative to a horizontal axis 222 arranged in the vertical plane and passing through the base portion 204. In the vertically upward position (FIG. 6), the tip portion 214 is arranged above the base portion 204 and the vector connecting the lower end of the lower portion 212 of the boom 210 and the outer end of the tip portion 214 of the boom 210 forms an angle, in the vertical plane, of more than 80 degrees relative to the horizontal axis 222 passing through the base portion 204. It should be noted that these angles are defined when the base portion 204 is in the orientation which would be its normal operating position.

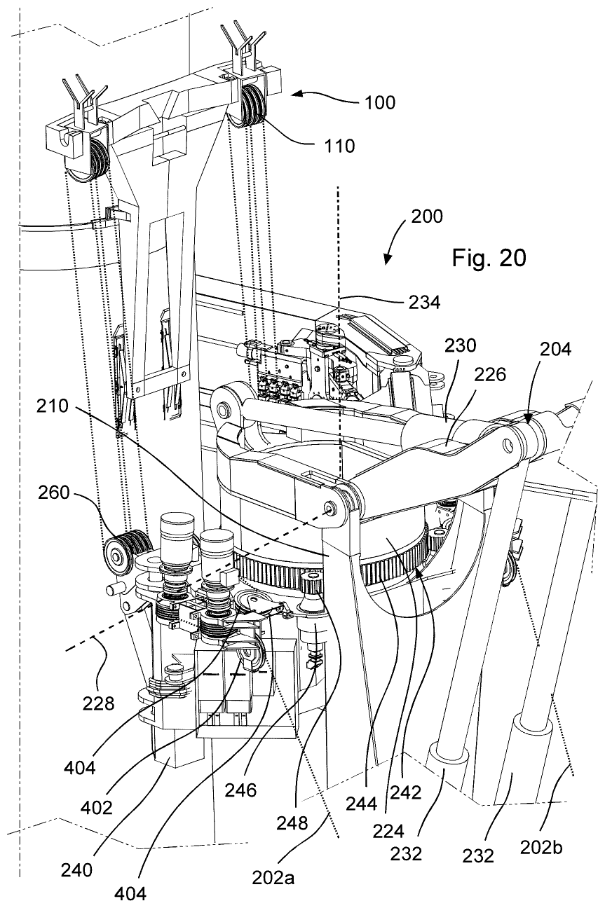

As shown more clearly in FIGS. 20 to 24, the base portion 204 of the crane 200 includes a slew platform 224 (i.e., a first base portion) and a raise mechanism 226 (i.e., a second base portion). The raise mechanism 226 is in the form of an arm pivotally connected to the slew platform 224 about a first horizontal axis 228. As shown, the boom 210 is also pivotally connected to the slew platform 224 about the same first horizontal axis 228. To enable the pivoting of the raise mechanism 226 with respect to the slew platform 224, the crane 200 includes a first hydraulic actuator 230 arranged between the slew platform 224 and the raise mechanism 226. Further, the crane 200 includes two second hydraulic actuators 232 connected between the boom 210 and the raise mechanism 226. Accordingly, to move the boom 210 between the vertically upward position and the vertically downward position, both the first hydraulic actuator 230 and the second hydraulic actuators 232 are operated. For example, to move the boom 210 from the vertically downward position to the vertically upward position, at first, the first hydraulic actuator 230 is retracted and then the second hydraulic actuators 232 are retracted. This arrangement allows the boom 210 arm to move more than 180 degrees about the horizontal axis 228.

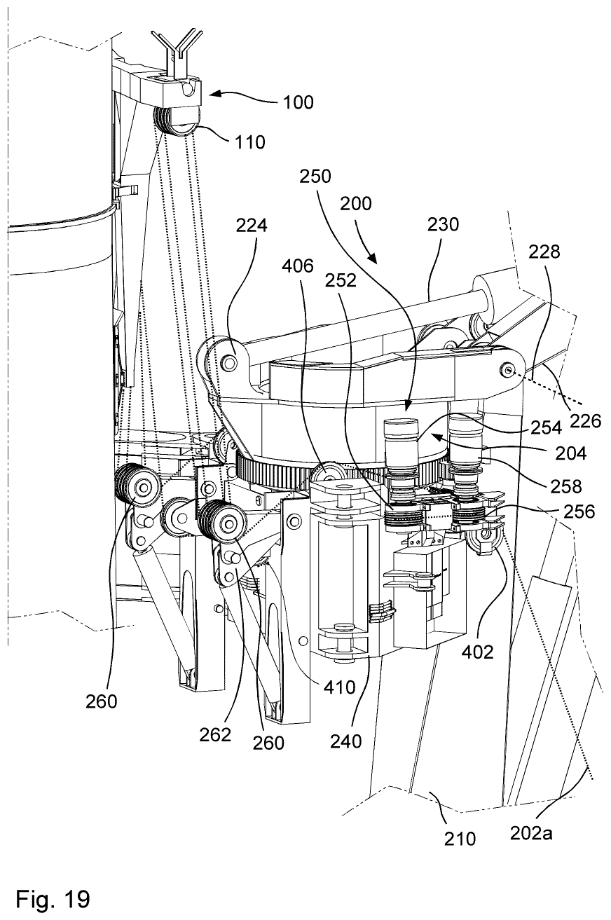

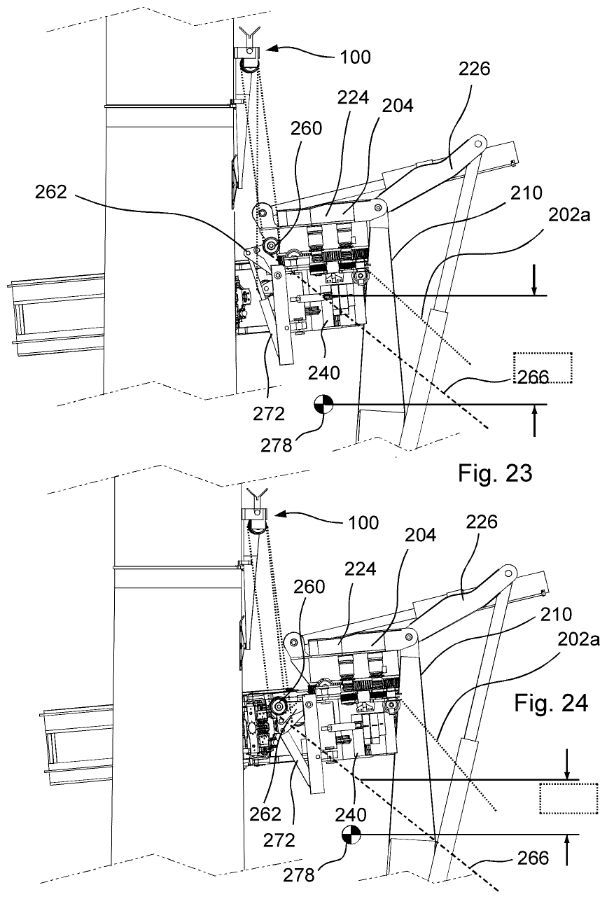

Additionally, the boom 210 is also configured to rotate about a vertical axis 234 relative to the base portion 204 by more than 180 degrees from an initial position in a first direction and more than 180 degrees from an initial position in a second direction opposite to the first direction. To enable the rotation of the boom 210 about the vertical axis 234, the base portion 204 includes, as best shown in FIG. 19 and FIG. 23, a main crane body 240 (i.e., a third base portion) arranged vertically below the slew platform 224, and the slew platform 224 is rotatably coupled to the main crane body 240. It may be appreciated that the arms 206 of the crane 200 are pivotally connected to the main crane body. Further, to enable the rotation of the slew platform 224 relative to the main crane body 240, the crane 200 includes a slew mechanism 242 having a ring gear 244 coupled to the slew platform 224, and a drive mechanism including a motor 246 and a drive gear 248 operatively coupled to motor 246 and arranged in engagement with the ring gear 244 to rotate the ring gear 244 and thereby the slew platform in response to the rotation of the motor 246. The motor 246 is supported on the main crane body 240.

The crane 200 in this embodiment also comprises a wire and pulley system comprising two lifting wires 202a, 202b and a number of pulleys. The wire and pulley system has two purposes. The first purpose is to act as a lifting system to lift loads with the crane 100 via the lifting hook 220 when the crane is in its operating position, see for example FIGS. 6, 7, 14 and 15. The second purpose is to lift the crane 200 itself so that the crane can move up and down the tower, see for example FIGS. 2, 3 and 11. The wire and pulley system will be described in more detail below with regards to FIGS. 19 to 33. In the FIGS. 1 to 18, the details of the pulley system are shown simplified as they would just complicate the figures if shown in detail. For example, in order to lift the loads required, the lifting wires 202a, 202b are arranged with multiple pulley systems with the lifting wires 202a, 202b running back and forth between multiple sheaves in the pulley blocks to reduce the loads in the wire. For example, in the current embodiment, a first lifting wire 202a runs back and forth between the hoist block 100 and the crane 200 four times and a second lifting wire 202b also runs back and forth four times. Hence, there are 18 wire segments between the hoist block 100 and the crane 200. In the figures only one or two lifting wire segments are shown to schematically show the routing of the wires.

The lifting wires 202a, 202b are schematically shown using thick dotted lines to schematically illustrate how the lifting wires 202a, 202b could be routed. The wires 202a, 202b are shown overly simplified to illustrate the concept. Also, not all sections of the wires are shown, just enough to illustrate the routing. In a real world system, additional details would be provided to ensure safety, strength and function. The person skilled in the art will understand the concept of the current disclosure and together with the more detailed illustrations in FIGS. 19 to 33, be able to provide a wire and pulley system which fulfils the demands for a real world system.

The lifting wires 202a, 20b are mainly controlled via the two ground winches 20a, 20b located on the ground, close to the base of the tower. The winches 20a, 20b are not shown in detail, but their location is shown with the reference numerals 20a, 20b. Hence, the crane 200 itself does not have to comprise a large lifting winch and does not have to be provided with power to lift the wind turbine components. The main operation and power supply can remain on the ground. In the current embodiment, small additional drives/winches and power supplies are arranged on the crane 200 as will be described later on, however the main lifting power is provided via the winches 20a, 20b on the ground.

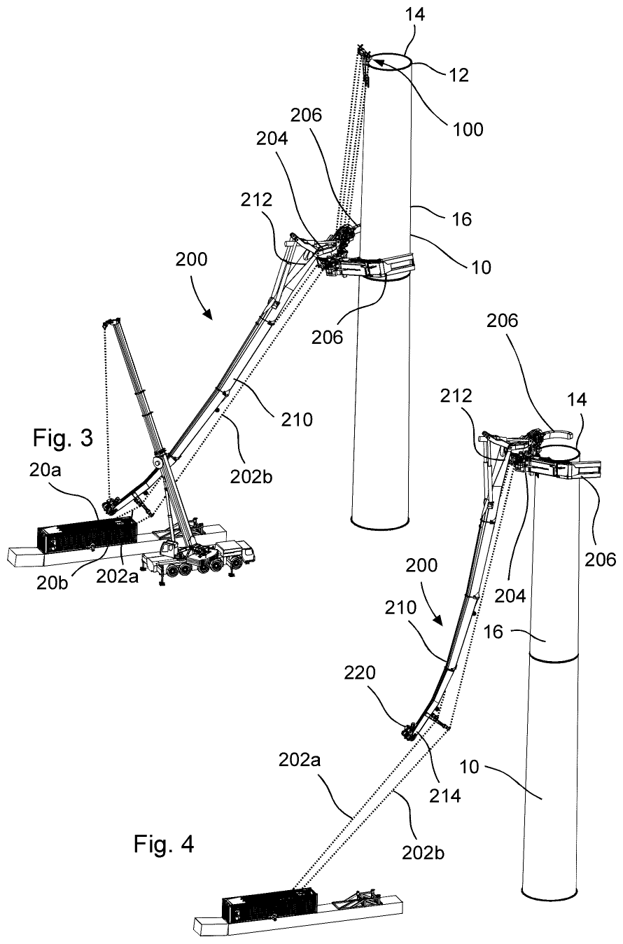

FIGS. 3 and 4 show further steps in the assembly procedure. In these steps, the crane 200 is moved to the top end 14 of the base tower section 10 using the ground winches 20a, 20b with the boom 210 of the crane 200 extending vertically downwardly of the base portion 204. Once the base portion 204 reaches the top end 14 of the tower section 10, the arms 206 are secured to the flange 12 of the tower section 10, by rotating the arms inwardly towards the tower section as shown in FIG. 5.

Subsequently, the method includes pivoting the boom 210 about a horizontal axis 228 to move the boom 210 to the vertically upward position, as shown in FIG. 6. In the vertically upward position, the tip portion 214 of the boom 210 is arranged above the base portion 204 of the crane 200. The crane 200 has now been moved to the top of the base tower section 10 and is firmly connected to the base tower section 10 via the arms 206. The crane 200 is now ready to lift the next tower section 50 into place.

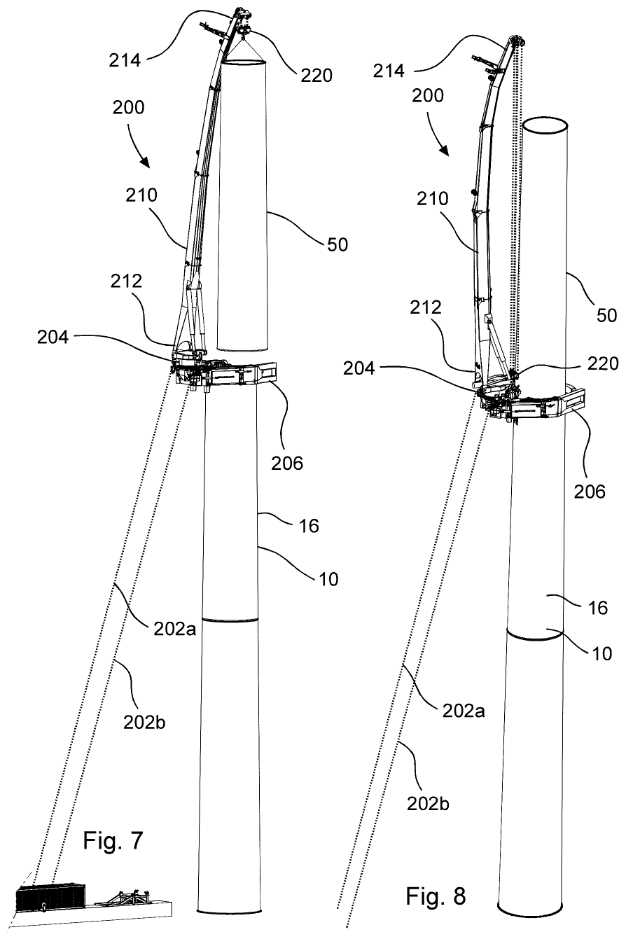

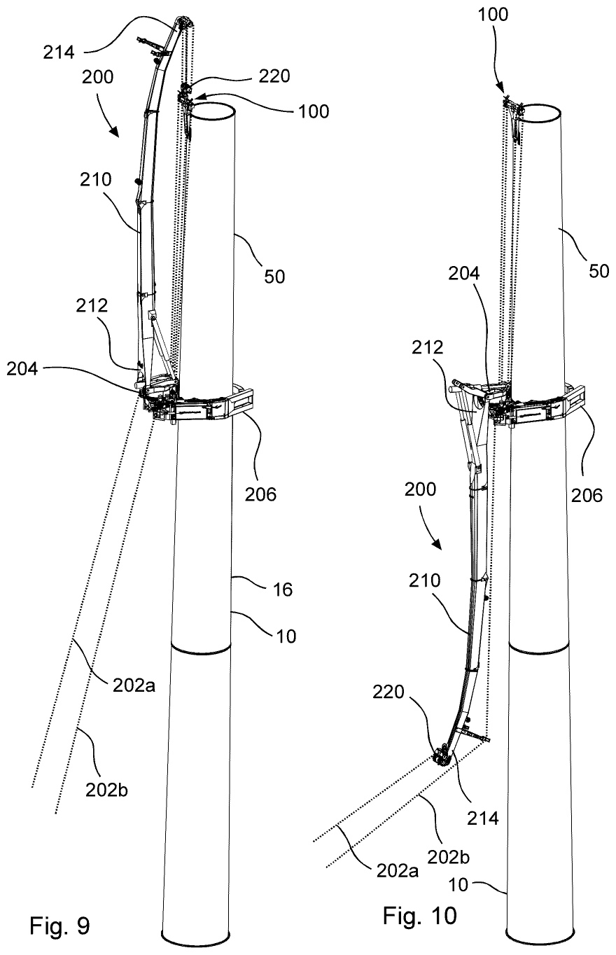

FIG. 7 shows how the crane 200 lifts the next tower section 50 and positions the next tower section 50 onto the base tower section 10. Upon attaching the next tower section 50 on top of the base tower section 10, the lifting hook 220 of the crane is lowered from the tip of the crane and connected to the hoist block 100 (FIG. 8). The crane then lifts the hoist block upwardly. Due to the design of the hoist block 100 in this embodiment (described in more detail later on), the hoist block 100 disengages from the bracket 11 on the flange 12 of the base tower section 10 and is lifted upwardly to the top end of the next tower section 50 using the lifting hook 220 where it is connected to a bracket on the flange of the next tower section 50, as shown in FIG. 9.

Upon positioning the hoist block 100 and engaging the hoist block 100 with the bracket on the flange of the next tower section 50, the boom 210 is moved to the vertically downward position such that the top end of the boom 210 is positioned downwardly of the base portion 204, as shown in FIG. 10. This puts the crane 100 in a stable position with respect to the lifting wires 202a, 202b as will be described in more detail later on. Thereafter, the arms 206 are operated and pivoted away from the base tower section 10, disengaging the arms 206 from the base tower section 10, as shown in FIG. 11. Accordingly, the crane 200 is supported only by the lifting wires 202a, 202b extending from the ground winches 20a, 20b to the base portion 204 of the crane 200 and then to the hoist block 100, and from the hoist block 100 to the base portion 204 of the crane 200. It is to be noted that the lifting wires 202a, 202b also run inside and along the crane boom 210 from the base portion 204 to the lifting hook 220 via a pulley system inside the crane 200 and boom 210 as will be described in more detail below. When the lifting hook 220 is in a lowered position, retracting the wires 202a, 202b via the ground based winches 20a, 20b will cause the lifting hook 220 to be lifted and when the lifting wires 202a, 202b are extended, the lifting hook 220 will be lowered. However, when the lifting hook 220 has been lifted to the tip of the boom 210, then further retraction of the wires 202a, 202b will result in the crane 200 itself being lifted towards the hoist block 100.

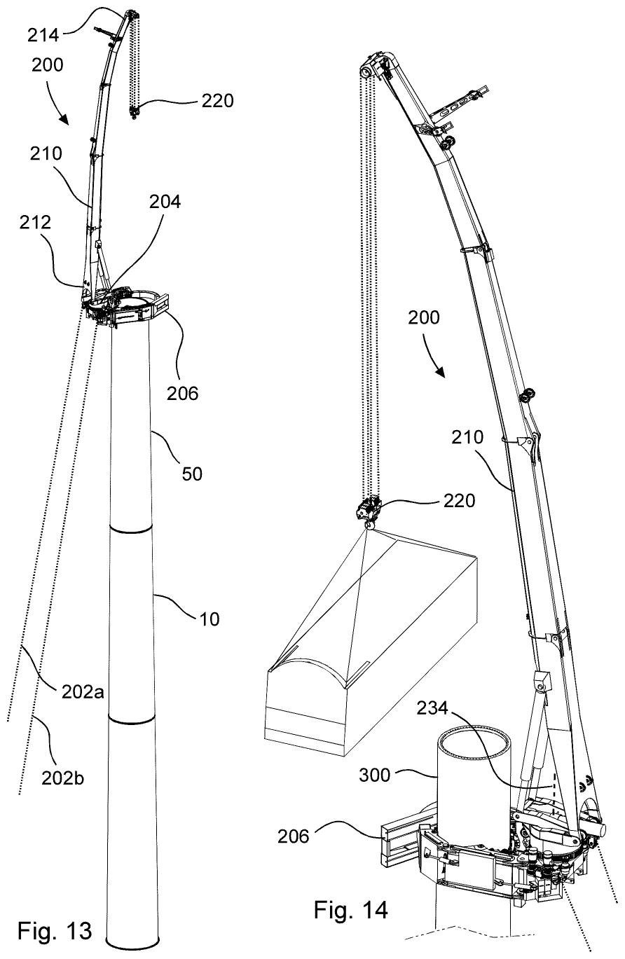

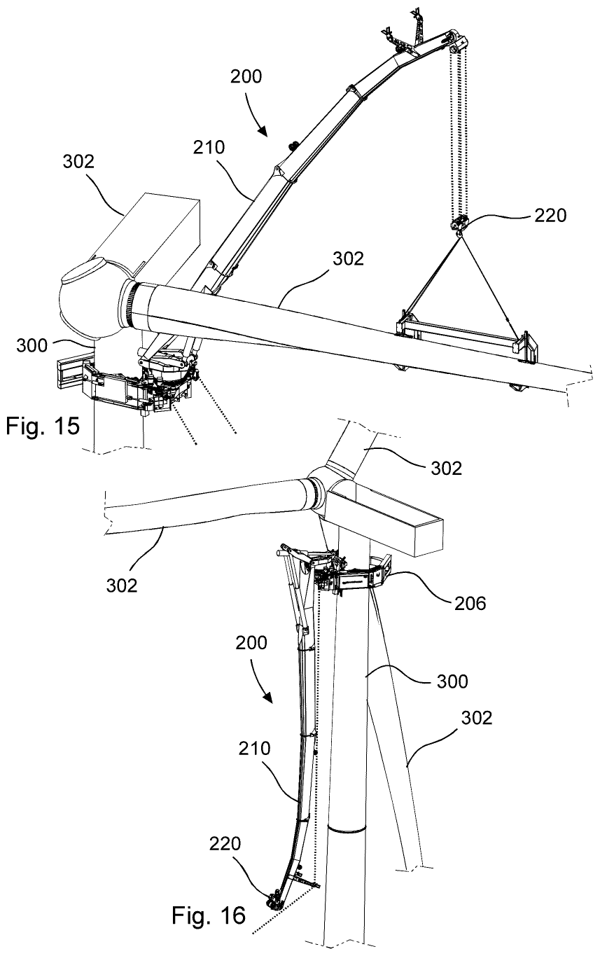

The method further includes, lifting the crane 200 with the boom 210 arranged in the vertically downward position to the top end of the next tower section 50 by operating the ground winches 20a, 20b, as shown in FIG. 12. Upon reaching the top end of the next tower section 50, the arms 206 are pivoted in and engaged with the flange of the next tower section 50. In this manner, the crane 200 is again supported on the tower of the wind turbine. Subsequently, the boom 210 is pivoted and moved to the vertically upward position, as shown in FIG. 13. Now the crane 200 is ready to lift another tower section. In this manner, all the tower sections of the tower of the wind turbine are lifted and coupled to each other to assemble the tower of the wind turbine. When the final tower section has been assembled, the crane 200 is moved to the top of the tower 300, as shown in FIGS. 14 and 15. It should be noted that in this embodiment, when the nacelle is to be attached to the tower, the nacelle occupies more space than a tower section. Hence, there is less room for the crane itself. In this embodiment, the uppermost tower section is therefore provided with an extra flange located a short distance below the top end of the uppermost tower section. The crane 200 is therefore connected to the uppermost tower section at a certain distance from the top end of the uppermost tower section. This can be seen in FIGS. 14-18.

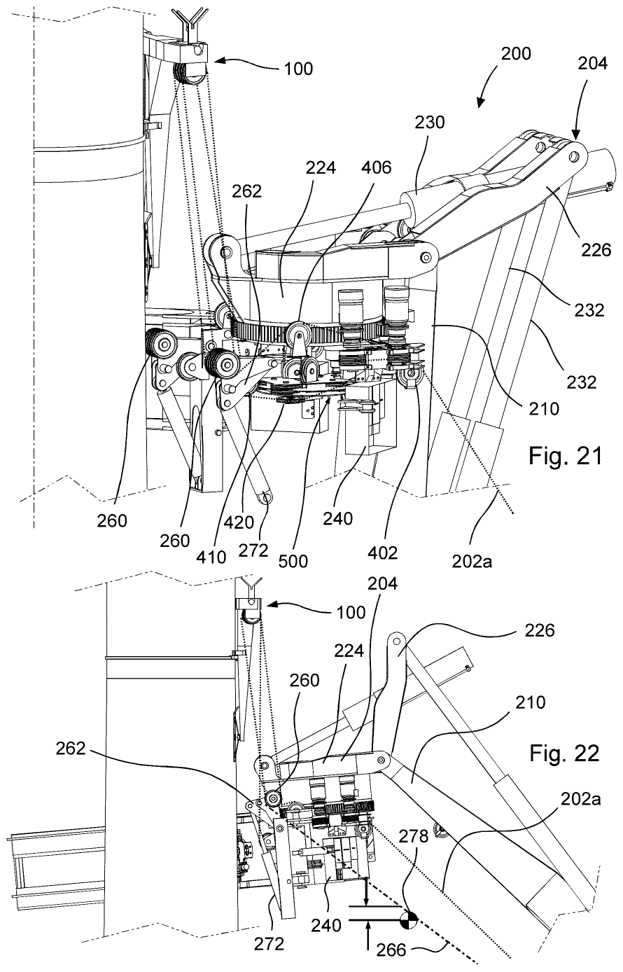

Once the tower 300 of the wind turbine is completely installed, other components of the wind turbine, such as, nacelles (FIG. 14), hubs, blades (FIG. 15), etc. are lifted and installed with the help of the crane 200. For facilitating an installation of the blades 302, the boom 210 is adapted to pivot about the vertical axis 234 in a first direction and in a second direction opposite to the first direction from an initial position of the boom 210. In the illustrated embodiment, the boom 210 is able to pivot approximately 330 degrees in both direction from the initial position. A mechanism to allow the boom 210 to move in both directions without causing entanglement of lifting wires 202a, 202b is described later with reference to FIGS. 21 and 28 to 33.

For the sake of understanding, FIG. 14 shows the crane 200 with the base portion 204 in the orientation when the crane 200 is in its operating mode. Likewise, in a vertical plane passing through the boom 210, the boom 210 forms an angle of around 80 degrees from a horizontal plane passing through the base portion 204. This angle is typically called the “boom angle” when discussing cranes. In a horizontal plane passing through the base portion 204, the boom 210 forms an angle of around 15 degrees from a horizontal vector extending from the centre of the base portion and passing through the centre of the tower section. This angle is typically called the “slew angle” when discussing cranes. In contrast in FIG. 15, in a vertical plane passing through the boom 210, the boom 210 forms an angle of around 45 degrees from a horizontal plane passing through the base portion 204. In a horizontal plane passing through the base portion 204, the boom 210 forms an angle of around 180 degrees from a horizontal vector extending from the centre of the base portion 204 and passing through the centre of the tower section. As can be imagined, the loading of the crane 200 and the flange 12 on the tower section is very different when these two situations are compared.

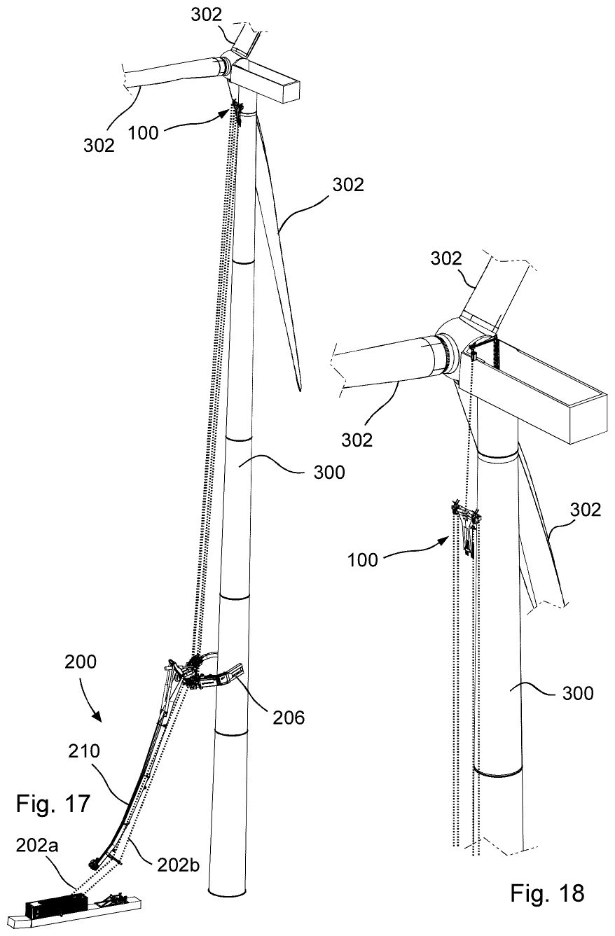

Upon completion of mounting and installing the components of the wind turbine, the crane 200 is lowered to the ground. For so doing, the boom 210 is first pivoted to the vertically downward position relative to the base portion 204 with the arms 206 of the crane 200 being still engaged to the tower 300, as shown in FIG. 16. Subsequently, the arms 206 are pivoted out relative to base portion 204 to disengage the arms 206 from the tower 300. In this position, the crane 200 is supported by the lifting wires 202a, 202b only, as shown in FIG. 17. To lower the crane 200 to the ground, the ground winches 20a, 20b are operated. Once the crane 200 is lowered, the hoist block 100 is disengaged from the bracket 11 of the tower section and lowered using a second light weight crane 800 arranged in the nacelle at a top of the wind turbine, as shown in FIG. 18.

Referring to FIGS. 19 to 21, a routing of the lifting wires 202a, 202b from the ground to the hoist block 100 via the base portion 204 and from the hoist block 100 to the lifting hook 220 via the base portion 204 and the boom 210 is now explained. As shown, the first lifting wire 202a extends from a first ground winch 20a to a first base sheave 402 fixedly connected to the base portion 204 and oriented vertically. A portion of the first lifting wire 202a extends along a periphery of the first base sheave 402 and thereafter, the first lifting wire 202a moves to a first traction winch 250 of the crane 200. As shown, the first traction winch 250 is mounted on the main crane body 240 and includes two motors and two horizontally oriented drums driven by the motors: a front drum 252 driven by a first motor 254 and a rear drum 256 driven by a second motor 258. The first lifting wire 202a extends to the front drum 252 from the first base sheave 402, partially circles and wraps around the periphery of the front drum 252 and then moves back to the rear drum 256. Thereafter, the first lifting wire 202a wraps around a portion of the outer periphery of the rear drum 256 and moves to a second base sheave 404. Although only a single round of wrapping of the first lifting wire 202a between the front drum 252 and the rear drum 256 is shown schematically in the figures, it may be appreciated that there are multiple rounds of wrapping of the first lifting wire 202a between the front drum 252 and the rear drum 256, before the first lifting wire 202a is extended to the second base sheave 404. The traction winches are operated to create differential tension between a section of the lifting wire that extends between the associated ground winch and the traction winch and a section of wire that extends from the traction winch to the hoist block. The principle of operation of the traction winches in this embodiment is well known in the art and is sometimes called a double drum Capstan winch. Other forms of traction winch are also possible. The traction winches of the current embodiment are of the kind which have a wire passing through the winch. In these types of winches, there are two free ends of the wire passing through the winch. This is in contrast to other types of winches where the wire is rolled onto a drum. In such cases, only a single free end is available.

Additionally, the second base sheave 404 is arranged proximate to the rear drum 256 and is arranged at a slight angle to the horizontal. The first lifting wire 202a extends from the rear drum 256 to the second base sheave 404 and is routed to a vertically oriented base sheave 406 disposed proximate to the front sheave 252. The angle of the second base sheave 404 is chosen such that the first lifting wire 202a is tangential to the vertically oriented base sheave 406 when the first lifting wire 202a reaches the vertically orientated base sheave 406. The first lifting wire 202a is then extended to and supported on a main crane lifting pulley block 260 from the vertically oriented base sheave 406. The main crane lifting pulley block 260 is arranged proximate to the vertically oriented base sheave 406 and is mounted on a beam 262 that is pivotally coupled to the main crane body 240 of the base portion 204. The main crane lifting pulley block 260 is configured to be moved between a raised position and a lowered position to control a position of the lifting wires of the crane with respect to the COG of the crane 200 while lifting the crane 200 upwardly along the tower section. This will be described in more detail with respect to FIGS. 22-24.

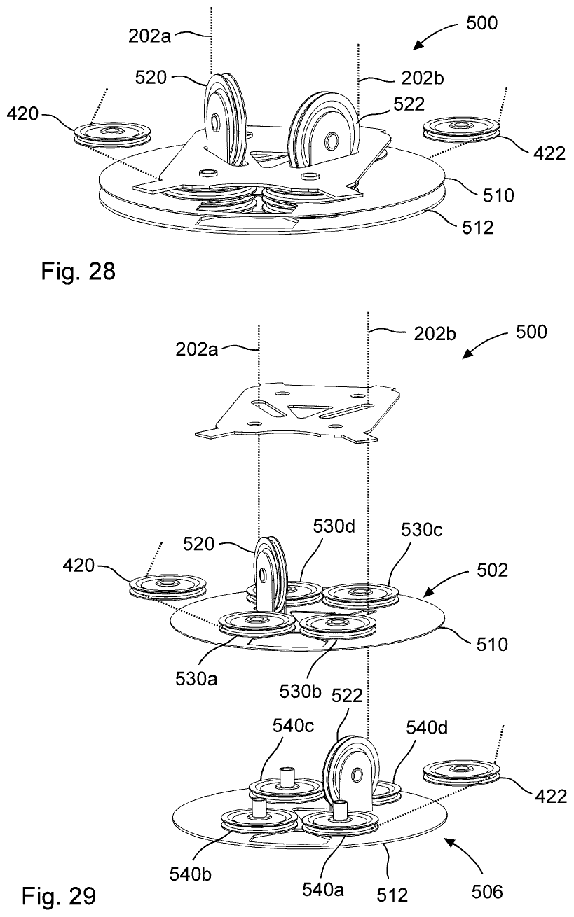

The first lifting wire 202a is arranged encircling at least a lower portion of a sheave of the main crane lifting pulley block 260 and is routed/extended to a sheave of a hoist pulley block 110 of the hoist block 100. Although a single wire section is shown to extend from the main crane lifting pulley block 260 to the hoist pulley block 110, it may be appreciated that the first lifting wire 202a is routed multiple times between the main crane lifting pulley block 260 and the hoist pulley block 110 before being routed to a third base sheave 410 coupled to the base portion 204, i.e., the main crane body 240, that may be arranged proximate to the main crane lifting pulley block 260. From the third base sheave 410, the first lifting wire 202a moves to a slew pulley assembly 500 arranged inside the main crane body 240 that prevents the entanglement of the lifting wires 202a, 202b during the rotation of the boom 210 about the vertical axis 234 in both directions from an initial position by more than 180 degrees. A structure and a function of the slew pulley assembly 500 will be discussed later with reference to FIGS. 28-33. After exiting the slew pulley assembly 500, the first lifting wire 202a is routed to the lifting hook 220 along a length of the boom 210. The crane 200 includes an identical pulley system along which a second lifting wire 202b is extended from the associated second ground based winch 20b to a second traction winch 280, and then to the main crane lifting pulley block 260, then the hoist pulley block 110, then to the slew pulley assembly 500 and then routed to the lifting hook 220.

Referring to FIGS. 22 to 24, a movement of the main crane lifting pulley block 260 between the raised position and the lowered position is shown. During the lifting of the crane 200, it is desired to keep the COG 278 of the crane below the axis of rotation of the crane/wire system. The axis of rotation of the crane/wire system, is defined by the location of the ground winches 20a, 20b and the location of the points where the lifting wires 202a, 202b leave the base portion 204 of the crane 200, in this case, the main crane lifting pulley blocks 260. The axis of rotation is schematically shown by the dashed-dotted line 266 in FIGS. 22-24. The axis 266 as well as the COG 278 are shown schematically in the figures, in a real life situation, the actual position of the COG 278 and/or the axis 266 could be different, but the trends shown in the figures are representative of the real life situation.

If the crane 200 rotates about the axis 266, then the entire operation will have to be terminated as the crane 200 will wrap around the wires 202a, 202b and lock itself in position. While the crane has a certain amount of stability due to the fact that the two wires are spaced apart, it can be imagined that the higher the COG 278 is arranged above the axis of rotation 266, then the greater the instability and the greater the risk for rotation of the crane 200 about the wires 202a, 202b. The lower the COG 278 is arranged below the axis of rotation 266, the more stable the system will be. As such, when lifting the crane 200, the boom 210 is put into the downward position to increase the stability of the lifting operation. The operation of the main crane lifting pulley blocks 260 for the lifting wires 202a, 202b is explained with reference to the main crane lifting pulley blocks 260 associated with the first lifting wire 202a, and it may be appreciated that the main crane lifting pulley block associated with the second lifting wire 202b is similarly operated.

During the lifting of the crane 200, the boom 210 is arranged in the vertically downward position in order to keep the COG 278 of the crane 200 below the axis of rotation 266. By comparing FIGS. 22 and 23, the effect of the position of the boom 210 can be seen on the COG 278 of the crane 200 with respect to the axis of rotation 266. In FIGS. 22 and 23, the main crane lifting pulley block 260 is in the raised position, and therefore closer to the base portion 204.

The main crane lifting pulley block 260 is moved to the lowered position when the crane 200 gets closer to the hoist block 100 to make space for accommodating the hoist block 100 and to prevent an interference between the hoist block 100 and the pulley block 260. As illustrated, the crane 200 includes a hydraulic cylinder 272 to move the pulley block 260 between the raised position and the lowered position. It may be envisioned that the main crane lifting pulley blocks 260 associated with both the lifting wires 202a, 202b are moved simultaneously and in tandem between the raised position and the lowered position to control the position of the wires 202a, 202b with respect to the COG of the crane 200.

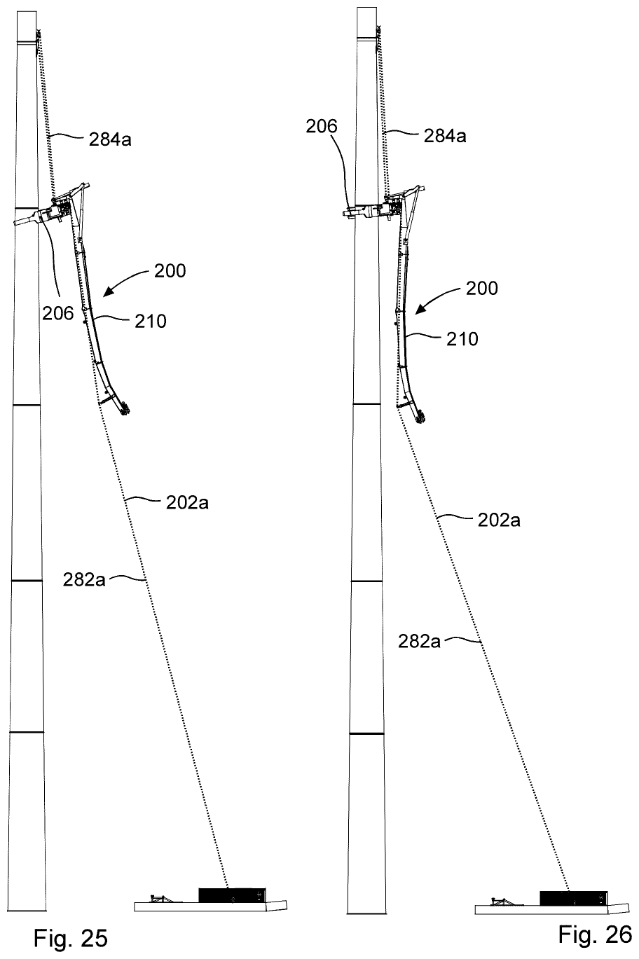

Referring to FIGS. 25 to 27, a working and purpose of the two traction winches 250, 280 for lifting the crane 200 upwardly from the ground to the tower section as well as the movement of the crane 200 towards the tower section in the horizontal direction is explained. As shown, each of the lifting wires 202a, 202b includes a first wire section 282a, 282b that extends from the corresponding ground winch 20a, 20b to the base portion 204 generally, and to the corresponding traction winches 250, 280, specifically, and a second wire section 284a, 284b that extends from the associated traction winch 250, 280 to the hoist block 100. The traction winches 250, 280 are operated to create a differential tension between the first wire sections 282a, 282b and the second wire sections 284a, 284b. During lifting of the crane 200, the traction winches 250, 280 can be operated in addition to the ground winches 20a, 20b to adjust the tension in the first wire sections 282a, 282b relative to the second wire sections 284a, 284b. It can be imagined, that if the tension in the first wire sections 282a, 282b was lowered, then the crane 200 would move closer to the tower 300. The crane 200 would likewise move away from the tower 300 if the tension in the first wire sections 282a, 282b is increased. In general, the tension in the second wire section is dependent on the weight of the crane itself. In the case where the traction winches 250, 280 are not active, the tension in the first and second wire sections would be the same and the crane would be pulled away from the tower. By placing traction winches on the crane itself, the load of the crane can be at least to some extent be supported by the traction winches on the crane. This allows the tension in the first wire sections to be lowered and allows the crane to move closer to the tower. This also allows the sideways loads on the tower to be reduced.

It may be appreciated that the traction winches 250, 280 and the ground winches 20a, 20b are operated so as to avoid/prevent jerks in the lifting wires 202a, 202b during lifting of the crane 200 from the ground. It may be appreciated that for lifting the crane 200 without causing any rotation of the crane 200, the traction winches 250, 280 are operated such that the tension in the second wire section 284a of the first lifting wire 202a and the tension in the second wire section 284b of the second lift wire 202b are identical.

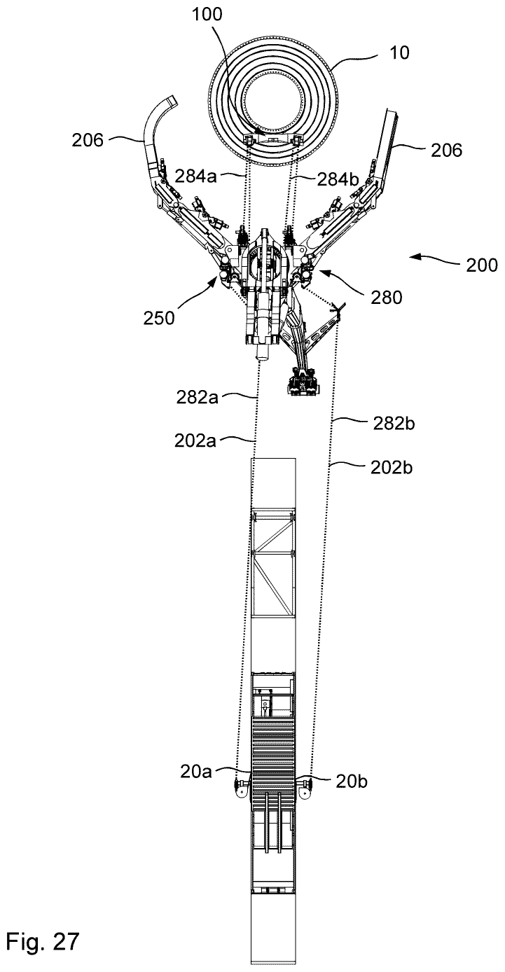

However, the traction winches 250, 280 may be operated independently to each other to create differential tensions between the second wire sections 284a, 284b of the two lifting wires 202a, 202b. In the case of a differential tension between the second wire sections 284a, 284b of the two lifting wires 202a, 202b, a torque is applied on the crane 200 to twist the crane 200 with respect to the tower section 50. This can be used to properly align the arms 206 with the tower section 50, as can be seen in FIG. 27 where the crane 200 has been twisted with regards to the tower. In some embodiments, tensions in the second wire sections 284a, 284b may be controlled manually by an operator. In some embodiments, a camera may be utilized to determine the positions of the arms 206 relative to the tower section, and a controller may control the traction winches 250, 280 to automatically align the arms 206 with the tower section based on input received from the camera.

Once the crane 200 has been positioned at a desired position, engaged with the flange and put into its operating position, the traction winches 250, 280 may be disengaged. From then on, the lifting can be performed by the ground based winches 20, 20b. In this embodiment, the traction winches 250, 280 are only used actively during the lifting of the crane 200, not during the wind turbine component lifting. To disengage the traction winches 250, 280, different options are available. In some embodiments, the drums of the traction winches 250, 280 are disengaged from the associated traction motors by operating suitable clutches arranged between the drums and the motors. In some embodiments, the traction winches 250, 280 are actively operated synchronously with the associated ground winches 20a, 20b such that the tension in the second wire sections 284a, 284b is identical to the tension in the first wire sections 282a, 282b. Accordingly, clutches may be omitted and there is no need to disengage the drums from the motors to disengage the traction winches 250, 280 from the lifting wires 202a, 202b.

In some embodiments, the motors of the traction winches 254, 280 may be operated as a generator to generate electricity when there is no need to create differential tensions between the first wire sections 282a, 282b and the second wire sections 284a, 284b. For example, the motors of the traction winches may be operated as generators when the lifting wire is being used to lift a wind turbine component and/or the hoist block 100. The electric power generated by the generators in this mode of operation could be used to charge a battery located on the crane 200. The battery could be used to power the traction winch motors when needed. It should be noted that the idea of using a traction winch as a generator, could be the basis of a divisional application. Furthermore, this idea can be taken further. For example, in a situation where no traction winch is needed, but where there is a moving wire, one could arrange a pulley in contact with the wire which when turned, drives a generator. The generator could be used, for example, to charge a battery. One example of this (not shown) is at the tip of the crane where the lifting wire in some cases, needs to be given a push to allow the lifting hook 220 to be lowered when there is no load on the hook. In this situation, a traction winch has previously been used at the tip of the crane to pull the wire out. The traction winch is driven by a battery powered motor. According to this current idea, when the traction winch is not being used to push the wire, then the traction winch could drive the motor as a generator and charge the battery.

Referring to FIGS. 21, 28 and 29, the slew pulley assembly 500 that enables a routing of the lifting wires 202a, 202b from the main crane body 240 to the boom 210 and then to the lifting hook 220 without causing entanglement or interference between the two lifting wires 202a, 202b during the rotation of the boom 100 about the vertical axis 234 with respect to the main crane body 240 is shown. The lifting wires 202a, 202b are directed to the slew pulley assembly 500 via two base portion sheaves 420, 422 fixedly attached to a portion of the main crane body 240 and oriented in a horizontal direction. As shown, the first lifting wire 202a is routed to a first pulley arrangement 502 having four rotating sheaves, arranged in a first horizontal plane from a first base portion sheave 420, while the second lifting wire 202b is routed to a second pulley arrangement 506 having four rotating sheaves, arranged in a second horizontal plane. The first horizontal plane is the plane that passes through the centres of the sheaves of the first pulley arrangement 502, while the second horizontal plane is the plane that passes through the centres of the sheaves of the second pulley arrangement 506. Moreover, he second horizontal plane is arranged substantially parallel to and below the first horizontal plane. The first pulley arrangement 502 and the second pulley arrangement 506 are fixedly connected to the slew platform 224 (i.e., first base portion) and to the boom 210. Hence, when the boom 210 rotates about a vertical axis with respect to the main crane body 240, and the first and second pulley arrangements 502, 506 rotate together with the boom 210, while the two base portion sheaves 420, 422 are fixedly attached to the main crane body 240 which does not rotate when the boom 210 rotates.

As shown, the slew pulley assembly 500 includes a first support plate 510 rotatably supporting the sheaves of the first pulley arrangement 502 and arranged underneath the sheaves of the first pulley arrangement 502, and a second support plate 512 rotatably supporting the sheaves of the second pulley arrangement 502 and arranged underneath the sheaves of the second pulley arrangement 506. Accordingly, the first support plate 510 separates the first pulley arrangement 502 from the second pulley arrangement 506, and acts as a barrier to prevent interference between the first lifting wire 202a and the second lifting wire 202b. Moreover, the first support plate 510 covers the sheaves of the second pulley arrangement 506 from above.

Moreover, the slew pulley assembly 500 includes a first vertical sheave 520 extending vertically from the first support plate 510 and outwardly of the first support plate 510 in a vertical direction. The first lifting wire 202a is routed to the first vertical sheave 520 upon exiting the first pulley arrangement 502. The first vertical sheave 520 facilitates in routing the first lifting wire 202a from a horizontal direction to a vertical direction to the lifting hook 220. Similarly, the slew pulley assembly 500 includes a second vertical sheave 522 extending vertically from the second support plate 512 and outwardly of the first support plate 510. The second lifting wire 202b is routed to the second vertical sheave 522 upon exiting the second pulley arrangement 506. The second vertical sheave 522 facilitates in routing the second lifting wire 202b from a horizontal direction to a vertical direction to the lifting hook 220.

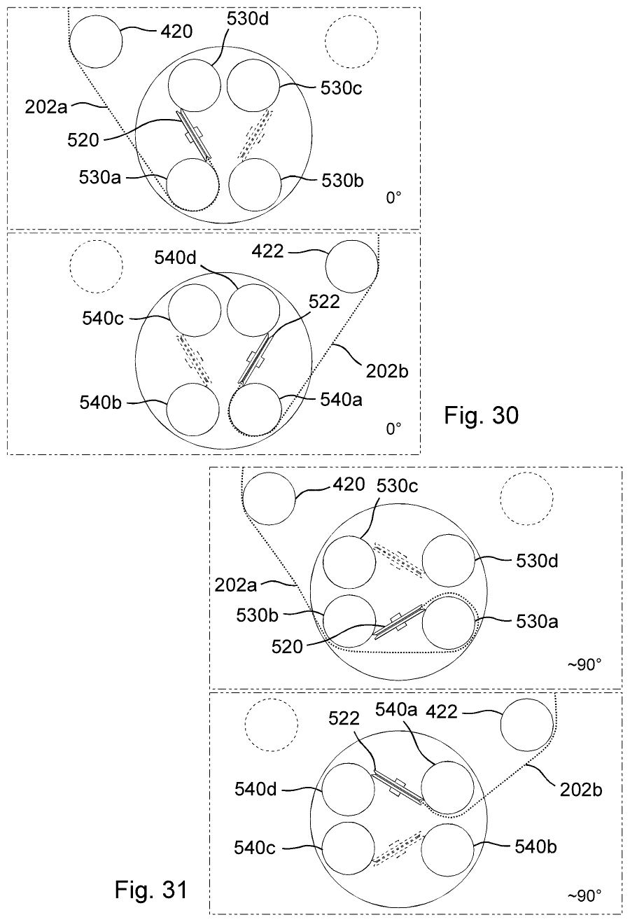

As illustrated in FIGS. 28 and 29, the first pulley arrangement 502 includes four sheaves arranged/arrayed circularly around a central axis of the first support plate 510. As shown, the four sheaves include a first sheave 530a, a second sheave 530b, a third sheave 530c, and a fourth sheave 530d. Further, the first vertical sheave 520 is arranged between the first sheave 530a and the fourth sheave 530d and is oriented such that an outer periphery of the first vertical sheave 520 is disposed tangentially to the outer periphery of the first sheave 530a when seen from top, as shown in FIGS. 30 to 33. It can be noted that in the figures, the first vertical sheave 520 is also disposed tangentially to the outer periphery of the fourth sheave 530d in this embodiment. However, this is not essential.

Similarly, the second pulley arrangement 506 includes four sheaves arranged/arrayed circularly around a central axis of the second support plate 512. As shown, the four sheaves include a fifth sheave 540a, a sixth sheave 540b, a seventh sheave 540c, and an eighth sheave 540d. Further, the second vertical sheave 522 is arranged between the fifth sheave 540a and the eighth sheave 540d and is oriented such that an outer periphery of the second vertical sheave 522 is disposed tangentially to outer periphery of the fifth sheave 540a when seen from the top, as shown in FIGS. 30 to 33. It can be noted that in the figures, the second vertical sheave 522 is also disposed tangentially to the outer periphery of the eighth sheave 540d in this embodiment. However, this is not essential.

Referring to FIG. 30, the routing of the first lifting wire 202a and the second lifting wire 202b through the slew pulley assembly 500 when the boom 210 is arranged at an initial position i.e., at zero degrees rotation is schematically shown when seen from above the mechanism. The upper figure shows the upper (first) pulley arrangement 502 and the lower figure shows the lower (second) pulley arrangement 506. As shown, at zero degrees rotation of the boom 210 relative to the vertical axis 234, the first lifting wire 202a extends to the first sheave 530a from the first base portion sheave 420 and is routed to the first vertical sheave 520 from the first sheave 530a. Accordingly, at zero degrees, the other sheaves 530b, 530c, 530d of the first pulley arrangement 502 remain disengaged from the first lifting wire 202a. Similarly, at the zero degrees rotation of the boom 210 about the vertical axis 234, the second lifting wire 202b extends to the fifth sheave 540a from the second base portion sheave 422 and is routed to the second vertical sheave 522 from the fifth sheave 540a. Accordingly, at zero degrees, the other sheaves 540b, 540c, 540d of the second pulley arrangement 506 remain disengaged from the second lifting wire 202b.

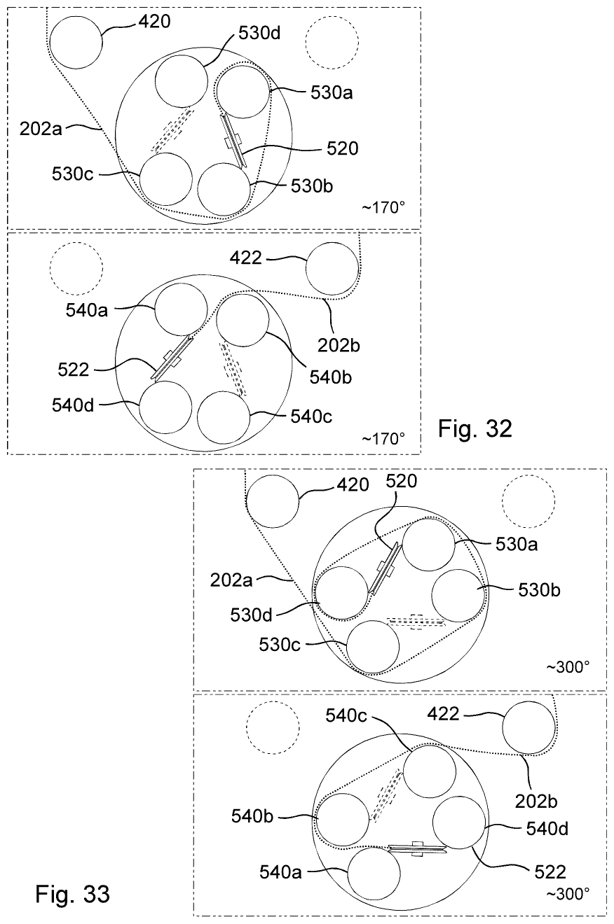

As the boom 210 is rotated about the vertical axis 234, the lifting wires 202a, 202b are extended to and supported by the additional associated sheaves before being routed to associated vertical sheaves 520, 522. For example, referring to FIG. 31, a routing of the first lifting wire 202a and the second lifting wire 202b is respectively shown through the first pulley arrangement 502 and the second pulley arrangement 506. As shown, at the −90 degrees rotation of the boom 210 from the initial position in the counter clockwise direction, the first lifting wire 202a extends to and is routed along the second sheave 530b from the first base portion sheave 420 and then extends to the first sheave 530a from the second sheave 530b before being routed to the first vertical sheave 520, while a length of the second lifting wire 202b that extend along the fifth sheave 540a is reduced and the second lifting wire 202b is routed to the second vertical sheave 522 from the fifth sheave 540a without being supported on any other sheaves of the second pulley arrangement 506. Similarly, upon further rotation of the boom 210 in the counter clockwise direction, for example, at 170 degrees rotation in the counter clockwise direction, shown in FIG. 32, the first lifting wire 202a extends to the third sheave 530c from the first base portion sheave 420 and then is routed to first vertical sheave 520 via the second sheave 530b and the first sheave 530a, while the second lifting wire 202b extends from the second base portion sheave 422 to the sixth sheave 540b and then extends to fifth sheave 540a from the sixth sheave 540b before being routed to the second vertical sheave 522 without being supported on any other sheaves of the second pulley arrangement 506.

As the boom 210 is rotated further in the counter clockwise direction, additional sheaves support the lifting wires 20a, 20b before being routed to the associated vertical pulleys 520, 522. For example, as shown in FIG. 33, at −300 degrees rotation in the counter clockwise direction, the first lifting wire 202a extends to the fourth sheave 530d from the first base portion sheave 420 and then is routed to first vertical sheave 520 via the third sheave 530c, the second sheave 530b and the first sheave 530a, while the second lifting wire 202b extends from the second base portion sheave 422 to the seventh sheave 540c and then extends to the sixth sheave 540b and the fifth sheave 540a, respectively, before extending to the second vertical sheave 522 without being supported on any other sheaves of the second pulley arrangement 506. It can be seen that if the mechanism rotates more than the approximately 300 degrees shown in FIG. 33, then the first lifting wire 202a would come into contact with itself. This would cause the lifting wire to rub against itself which would create a large amount of friction and be damaging to the wire. Hence, the current embodiment of the slew pulley assembly 500, permits a maximum rotation of the boom of around 300 degrees in both directions.

It may be envisioned that the first lifting wire 202a, when the boom 210 is rotated in the clockwise direction from the initial position, is routed and supported by horizontal sheaves 530a, 530b, 530c, 530d of the first pulley arrangement 502 in a manner similar to the second lifting wire 202b when the boom 210 is rotated in the counter clockwise direction, as descried above. Accordingly, the second lifting wire 202b, when the boom 210 is rotated in the clockwise direction from the initial position, is routed and supported by horizontal sheaves 540a, 540b, 540a, 540d, of the second pulley arrangement 506 in a manner similar to the first lifting wire 202a when the boom 210 is rotated in the counter clockwise direction.

It should be noted that as the boom 210 is rotated about the vertical axis, more or less of the lifting wires 202a, 202b will be wrapped up on the first and/or second pulley arrangement 502, 506. Furthermore, the first and second wires will be wrapped differently and hence the length change in the wires will be different. If the ground winches 20a, 20b and the traction winches 250, 280 do not move, then the amount of the wires wrapped up on the first and/or second pulley arrangement 502, 504 will cause the left and/or right sides of the lifting hook 220 to move up or down. To compensate/adjust for changes in the length of the lifting wires 202a, 202b due to rotation of the boom 210 around the vertical axis 234, a controller may control the ground winches 20a, 20b and/or the traction winches 250, 280 to avoid any undesired displacement during the movement of the boom 210. For so doing, in some embodiments, the controller may determine the angle of rotation of the boom 210 as well as the direction of the rotation of the boom 210 about the vertical axis 234. Based on these two parameters, the controller may estimate the increase or decrease in the lengths of the wires 202a, 202b that extend outwardly of the ground winches 20a, 20b. Accordingly, the controller may control the operation of the winches 20a, 20b to control the extension or retraction of the lifting wires 202a, 202b from the ground winches in order to keep the lifting hook 220 at a constant height and/or horizontal at any given height. In an embodiment, the controller may determine the desired angle of rotation of the boom 210 as well as the direction of the rotation of the boom 210 based on the displacement of a control lever, for example, a joystick, controlling the movement of the boom 210 about the vertical axis 234, and then adjust the winches of the first and/or second lifting wires accordingly to compensate for the motion of the boom.

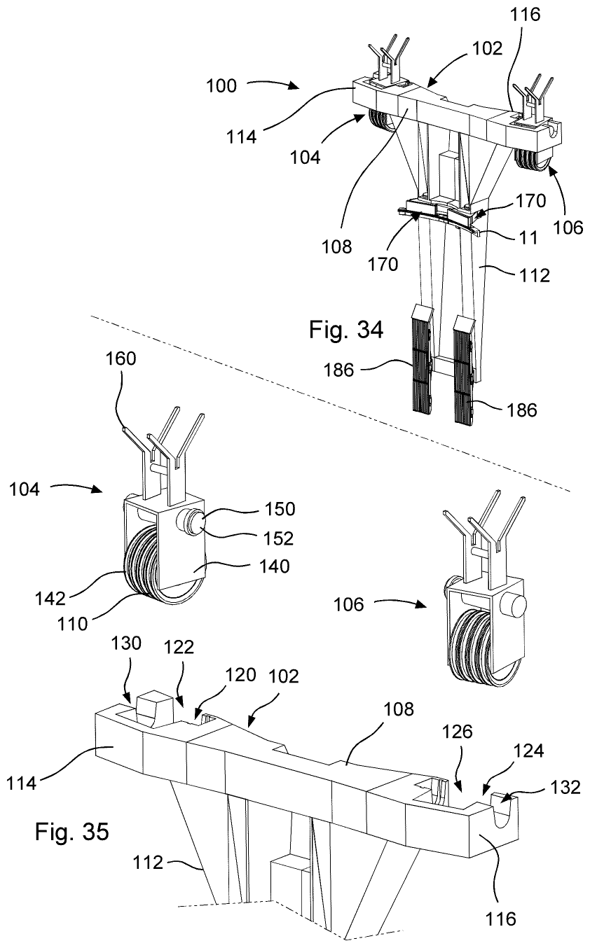

Referring to FIGS. 34 to 37, various structural details of the hoist block 100 are shown. As shown in FIG. 34, the hoist block 100 includes a frame portion 102, a first pulley block assembly 104 and a second pulley block assembly 106, removably coupled to the frame portion 102. The first pulley block assembly 104 is configured to support and route the first lifting wire 202a, while the second pulley block assembly 106 is configured to support and route the second lifting wire 202b. As shown in FIG. 35, the frame portion 102 includes a horizontally extending arm 108 and a column structure 112 extending vertically downwardly from the arm 108 from a central location of the arm 108. Accordingly, a first end portion 114 of the arm 108 is arranged on a first side of the column structure 112, while a second end portion 116 is arranged on a second side of the column structure 112. The arm 108 and column structure 112 form a T-like structure. The first end portion 114 defines a seat 120, for example, a first seat 120, for the first pulley block assembly 104. As shown, the first seat 120 is defined by a through opening 122 extending in vertical direction from an upper surface of the arm 108 and through the arm 108. Similarly, the second end portion 116 defines a seat 124, for example, a second seat 124, for the second pulley block assembly 106. As shown, the second seat 124 is defined by a through opening 126 extending in a vertical direction from the upper surface of the arm 108 and through the arm 108. Additionally, the arm 108 defines at least one retention structure, for example, a first retention structure 130 arranged at the first end portion 114 and a second retention structure 132 arranged at the second end portion 116. As shown, each of the retention structures 130, 132 includes two slots disposed such that associated seat 120, 124 is arranged between the two slots.

The first pulley block assembly 104 and the second pulley block assembly 106 are engaged with the frame portion 102 by inserting the first pulley block assembly 104 and the second pulley block assembly 106 into the through openings 122, 126 from a position vertically above the arm 108. The first pulley block assembly 104 and the second pulley block assembly 106 are identical, and therefore, for sake of clarity and brevity, only one pulley block assembly, for example, the first pulley block assembly 104, is explained in detail. As shown, the first pulley block assembly 104 includes a support structure 140 and four sheaves 142 rotatably engaged to the support structure 140. The four sheaves are arranged to rotate independently with respect to each other. The support structure 140 is configured to extend through the through opening 122 such that the sheaves 142 are arranged below the arm 108. Further, the first pulley block assembly 104 includes a coupler 150, for example, a pin 152, extending away from both sides of the support structure 140 in a lateral direction and arranged proximate to a top end of the support structure 140. The pin 152 is configured to rest inside the slots of the first retention structure 130 when the first pulley block assembly 104 engages with the arm 108. The engagement of the pin 152 with the slots prevents any downward movement of the first pulley block assembly relative to the frame portion 102, while allowing the first pulley block assembly 104 to be detached from the frame portion by a simple upward movement of the first pulley block assembly relative to the frame portion 102. One side of the seat is open, such that the wires of the pulley block can be disengaged from the seat by first lifting the pulley block and then moving the pulley block horizontally and perpendicularly away from the arm. According to the figures, it can be seen that the opening is on the side of the arm facing away from the tower section when the frame portion is attached to the tower section. In this way, the pulley block assemblies can be moved up and outwardly to separate the pulley block assemblies from the frame portion.

To facilitate a lifting of the first pulley block assembly 104 using a rope or a cable of another crane, the support structure 140 includes a lifting structure 160 to which a hook of another crane can be easily connected. As shown, the lifting structure 160 extends upwardly of the arm 108 in the assembly of the first pulley block assembly 104 with the arm 108. As the hoist block 100 includes multiple parts which can be easily separated, the hoist block 100 can be lowered to the ground from the tower 300 of the wind turbine with a smaller crane than would be necessary if the hoist block were to be lowered as a single component. For lowering the hoist block 100, the pulley block portions 104, 106 are disengaged from the frame portion 102 and lowered one by one after which the frame portion 102 is lowered.

More specifically, a light weight crane mounted in a nacelle of a wind turbine may be connected to the lifting structure 160 of the first pulley block assembly 104 and then move it upwardly and outwardly relative to the frame portion 102, thereby disengaging the first pulley block assembly 104 and its associated lifting wires from the frame portion 102. Thereafter, the first pulley block assembly and its associated lifting wires can be lowered to the ground by operating the light weight crane. Similarly, the second pulley block assembly 106 and its associated lifting wires is removed from the frame portion 102 and lowered to the ground. Subsequently, the frame portion 102 itself is lowered to the ground by disengaging the frame portion 102 from the flange 12 of the tower section 50.

It should be noted that modern wind turbine towers, are quite high and the components which need to be lifted are very heavy. Hence, a strong wire is needed. In addition, multiple pulley systems with a number of wraps of wires are needed to reduce the tensions in the wires. In the embodiment shown, four sheaves are shown on each pulley block assembly 104, 106. This means that there are eight wire sections associated with each pulley block assembly, or sixteen wire sections associated with the hoist block 100. If the tower is 200m high, then there are approximately 16×200m or 3.2 km of wire hanging from the hoist block 100. This is a very high load and the light weight crane located at the top of the nacelle is typically not strong enough to lift the hoist block 100 having both pulley block assemblies 104, 106 and their associated wires to the ground in one operation. Hence, the currently proposed structure has been developed where the pulley block assemblies 104, 106 and the frame portion 102 can be split up and lowered separately to the ground. This reduces the loads on the light weight crane significantly. While it would be obvious to put a larger light weight crane in the nacelle to solve the problem of the heavy block, the current solution of splitting the hoist block into multiple parts allows a smaller light weight crane to be used.

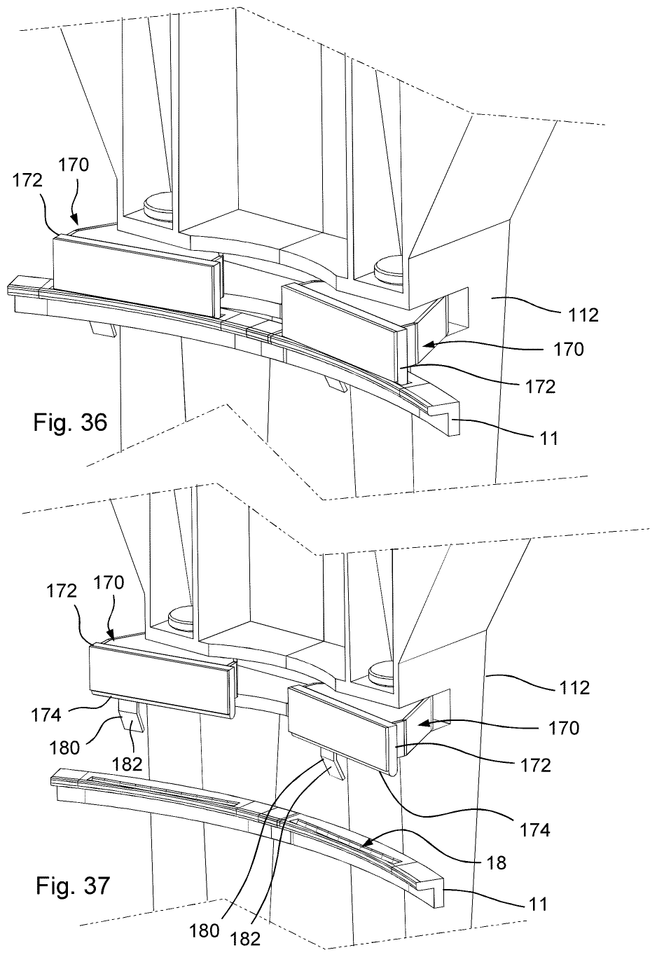

Additionally, the hoist block 100 of the current embodiment includes two engagement structures 170 arranged at an angle to each other. The engagement structures 170 are arranged to enable a coupling/engagement of the hoist block 100 with a bracket 11 mounted on the flange 12 of the tower section 10, 50. The engagement structure 170 includes a substantially rectangular block 172 or protrusion 172 pivotally coupled to the column structure 112 and extending outwardly of the column structure 112 in a forward direction. The pivoting of the block 172 facilitates an accurate alignment with and insertion into the curved recess 18 of the bracket 11. In some embodiments, the pivoting of the protrusion/block 172 relative to the column structure 112 may be omitted. As shown in FIG. 36, the block 172 includes a lower edge portion 174 that is inserted inside the arcuate recess 18 of the bracket 11 to couple the hoist block 100 with the tower section 10, 50. To enable a correct alignment of the recess 18 and the lower edge portion 174 of the block 172, during the engagement process of the hoist block 100 with the flange 12, the hoist block 100 may include a guide structure 180, for example, an angled plate 182 extending downwardly of the block 172 and connected to the block 172. As shown, the angled plate 182 is angled towards the column structure 112 from the block 172.

For engaging the hoist block 100 with the bracket 11 on the flange 12, the hoist block 100 is positioned above the bracket 11, and then moved vertically downwardly to insert the lower edge portion 174 of the block 172 inside the recess 18 of the bracket 11. In so doing, a lower end of the angled plate 182 comes into contact with the bracket 11, guiding the engagement structure 170 into alignment with the recess 18 when lowering the hoist block 100. As the hoist block 100 is lowered, the hoist block 100 is moved in a direction away from the tower section 10, 20 as the angled plate 182 slides along the outer edge of the bracket 11. Upon correct aligning of the lower edge portion 174 of the block 172 with the recess 18, the lower edge portion 172 is inserted inside the recess 18 when the hoist block 100 is further moved in the vertically downward direction. To disengage the hoist block 100 from the flange 10, the hoist block 100 is simply lifted in the upward direction. In this manner, the engagement structure 170 facilitates in engagement and disengagement of the hoist block 100 from the tower section 10, 50 without requiring tools and/or without requiring any actuators located in the hoist block. In this way, the hoist block is completely passive without any actively moving components. In the current embodiment, the hoist block 100 includes pads 186 arranged at a lower end of the column structure 112. The pads a but the outer surface of the body 16 of the tower section 10, 50 when the hoist block 100 is engaged with the tower section 10, 50.

It should be noted that it is important that the hoist block 100 engages the bracket 11 mounted on the flange 12 as close to the outer surface of the body of the tower section 10, 50 as possible. This reduces the bending moment on the bracket 11 and the flange 12 of the tower section 10, 50.

It is to be noted that the figures and the above description have shown the example embodiments in a simple and schematic manner. Many of the specific mechanical details have not been shown since the person skilled in the art should be familiar with these details and they would just unnecessarily complicate this description. For example, many of the specific materials used and the specific manufacturing procedures have not been described in detail since it is maintained that the person skilled in the art would be able to find suitable materials and suitable processes to manufacture the systems and mechanisms according to the current invention based on the disclosure in this specification together with his or her technical knowledge.

In the following, some specific examples of the different inventions mentioned above are provided. These examples could be converted into claims in one or more future divisional applications.

### Examples of the Second Invention

1. A crane system configured to facilitate an installation, a maintenance and/or a repair of a wind turbine said crane system comprising a hoist block, a wind turbine mounted crane, a ground based winch and a lifting wire,
   a. the crane comprising:
      i. a base portion;
      ii. a wind turbine connection mechanism connected to the base portion and configured to releasably engage with a wind turbine and arranged such that the base portion is supported by the wind turbine when the wind turbine connection mechanism of the crane is engaged with the wind turbine;
      iii. at least one traction winch located on the base portion of the crane,
   b. the hoist block comprising
      i. a wind turbine connection element configured to releasably engage with the wind turbine and arranged such that the hoist block is supported by the wind turbine when the wind turbine connection element is engaged with the wind turbine, and
      ii. at least one hoist pulley block, and
   c. where a first portion of the lifting wire is arranged to go from the ground based winch to the traction winch, a second portion of the lifting wire is arranged to go from the traction winch to the hoist pulley block and a third portion of the lifting wire is arranged to go from the hoist pulley block to the base portion of the crane, and
   d. wherein the traction winch is arranged to contribute to the tension of the second portion of the lifting wire such that the tension in the first portion of the lifting wire can be lower than the tension in the second portion of the lifting wire.
2. The crane system according to example 1, characterized in that the traction winch also contributes to the tension in the third portion of the lifting wire such that the tension in the second and third portions are the same.
3. The crane system according to example 1 or 2, characterized in that the crane system comprises two lifting wires and in that the crane comprises two traction winches, a first traction winch being associated with a first lifting wire and a second traction winch being associated with a second lifting wire.
4. The crane system according to example 3, characterized in that a portion of the second portion and/or the third portion of the first lifting wire is arranged on a first side of a vertical plane passing through the centre of the base portion and in that a portion of the second portion and/or the third portion of the second lifting wire is arranged on a second side of the vertical plane passing through the centre of the base portion.
5. The crane system according to example 3 or 4, characterized in that the first traction winch is arranged on a first side of a vertical plane passing through the centre of the base portion and in that the second traction winch is disposed on a second side of the vertical plane passing through the centre of the base portion.
6. The crane system according to any one of examples 3 to 5, characterized in that the crane system comprises two ground based winches.
7. The crane system according to any one of examples 3 to 6, characterized in that the two traction winches are controlled to differentially control tension in first portions of the two lifting wires to rotate the crane about a vertical axis passing through a centre of the base portion.
8. The crane system according to any one of examples 1 to 7, characterized in that in one mode of operation of the crane, the at least one traction winch is arranged to operate as a generator to charge a battery located on the crane.
9. The crane system according to any one of examples 1 to 8, characterized in that in one mode of operation of the crane, the at least one traction winch is arranged to synchronize its motion with the ground based winch to reduce the load on the wire.

### Examples of the Third Invention

10. A crane system configured to facilitate an installation, a maintenance and/or a repair of a wind turbine said crane system comprising a hoist block, a wind turbine mounted crane, a winch and a lifting wire,
   a. the crane comprising:
      i. a base portion;
      ii. a wind turbine connection mechanism connected to the base portion and configured to releasably engage with a wind turbine and arranged such that the base portion is supported by the wind turbine when the wind turbine connection mechanism of the crane is engaged with the wind turbine;
      iii. a main crane lifting pulley block
   b. the hoist block comprising
      i. a wind turbine connection element configured to releasably engage with the wind turbine and arranged such that the hoist block is supported by the wind turbine when the wind turbine connection element is engaged with the wind turbine, and
      ii. at least one hoist pulley block, and
   c. where a first portion of the lifting wire is arranged to go from the winch to the main crane lifting pulley block, a second portion of the lifting wire is arranged to go from the main crane lifting pulley block to the hoist pulley block and a third portion of the lifting wire is arranged to go from the hoist pulley block to the base portion, and
   d. wherein the crane further comprises a displacement mechanism for displacing the vertical and/or horizontal position of the main crane lifting pulley block relative to the base portion of the crane.
11. Crane system according to example 10, characterized in that the main crane lifting pulley block is displaced to keep the COG of the crane below the axis of rotation of the crane system.
12. Crane system according to example 10 or 11, characterized in that the displacement mechanism comprises a beam pivotably connected to the base portion and in that the main crane lifting pulley block is connected to a portion of the beam.
13. Crane system according to example 12, characterized in that the crane further comprises a linear hydraulic cylinder connected between the beam and the base portion and in that the linear hydraulic cylinder is arranged to pivot the beam when the linear hydraulic cylinder extends or retracts.
14. Crane system according to any one of example 10 to 13, characterized in that the main crane lifting pulley block is a first main crane lifting pulley block and in that the crane further comprises a second main crane lifting pulley block and a second lifting wire, said second main crane lifting pulley block being arranged parallel to the first main crane lifting pulley block and a first portion of the second lifting wire being arranged to go from the winch or from a second winch to the second main crane lifting pulley block, a second portion of the second lifting wire being arranged to go from the second main crane lifting pulley block to the hoist pulley block and a third portion of the second lifting wire being arranged to go from the hoist pulley block to the second main crane lifting pulley block, and wherein the crane further comprises a second displacement mechanism for displacing the horizontal and/or vertical position of the second main crane lifting pulley block relative to the base portion of the crane.
15. Crane system according to example 14, characterized in that the at least one hoist pulley block comprises a first hoist pulley block and a second hoist pulley block, the first lifting wire being arranged over the first hoist pulley block and the second lifting wire being arranged over the second hoist pulley block.
16. Crane system according to any one of examples 10 to 15, characterized in that the winch is a ground based winch.

### Examples of the Fourth Invention

20. A hoist block comprising
   a. a wind turbine connection element configured to releasably engage with the wind turbine and arranged such that the hoist block is supported by the wind turbine when the wind turbine connection element is engaged with the wind turbine,
   b. at least one hoist pulley block configured to support and route a lifting wire, and
   c. a frame portion supporting the at least one hoist pulley block, and
   d. wherein the frame portion comprises at least one retention structure and wherein the least one hoist pulley block includes a coupler adapted to be removably engaged with the at least one retention structure to enable a removable engagement of the at least one hoist pulley block with the frame portion.
21. Hoist block according to example 20, characterized in that the retention structure and the coupler are arranged such that the hoist pulley block can be disengaged from the retention structure by moving the hoist pulley block relative to the frame with a motion having a direction with a vertical component.
22. Hoist block according to example 20 or 21, characterized in that said at least one hoist pulley block is one of at least two hoist pulley blocks, and in that the retention structure is one of two retention structures in the frame portion separated by a horizontal distance and wherein each of the two hoist pulley blocks being independently disengageable from the frame portion by motion in a vertical direction.
23. Hoist block according to example 22, characterized in that said frame portion comprises a horizontal beam and a column structure, the horizontal beam arranged near the upper end of the vertical beam.
24. Hoist block according to example 22 or 23, wherein the frame portion includes a T shaped configuration.
25. Hoist block according to example 23 or 24, characterized in that the horizontal beam comprises the two retention structures and in that the two retention structures are two “seats” to support the two hoist pulley blocks at a horizontal distance apart from each other.
26. Hoist block according to any one of examples 23 to 25, characterized in that a lower portion of the column structure comprises pads adapted to abut an outer surface of the tower when the hoist block is engaged with the tower section.
27. Hoist block according to any one of examples 22-26, characterized in that the each of said two hoist pulley blocks comprises at least two separate pulley blocks which can be removed from said retention structures independently of each other.
28. Hoist block according to example 27 characterized in that a first of said at least two separate pulley blocks of one hoist pulley block is connected to a first of said at least two separate pulley blocks of another hoist pulley block such that the connected separate pulley blocks can be lifted simultaneously.

### Examples of the Fifth Invention

30. A hoist block comprising
   a. a wind turbine connection element configured to releasably engage with the wind turbine and arranged such that the hoist block is supported by the wind turbine when the wind turbine connection element is engaged with the wind turbine,
   b. at least one hoist pulley block configured to support and route a lifting wire, and
   c. a frame portion,
   d. and where the wind turbine connection element is arranged to engage a tower having a flange arranged extending radially outwardly from the tower, the flange being provided with a hoist block connection element, wherein the wind turbine connection element comprises at least one vertically downwards extending protrusion adapted to be removably connected to the hoist block connection element of the flange.
31. Hoist block according to example 30, characterized in that the hoist block connection element includes an elongated recess and in that the vertically downwardly extending protrusion extends inside the recess when the hoist block is engaged with a tower.
32. Hoist block according to example 30, characterized in that the flange comprises two elongated recesses and in that the hoist block comprises two elongated protrusions, the two elongated recesses and the two protrusions being arranged spaced apart from each other by a horizontal distance.
33. Hoist block according to example 32, characterized in that the two protrusions are arranged at an angle to each other.
34. Hoist block according to example 33, characterized in that the two protrusions are arranged pivotably with respect to the frame such that the angle between the two protrusions in the horizontal plane can be adjusted.
35. Hoist block according to any one of examples 31 to 34, characterized in that the hoist block includes at least one guide structure extending vertically downwardly of the at least one wind turbine connection element to guide an insertion of the at least one protrusion inside the at least one recess during the vertical downward movement of the hoist block.
36. Wind turbine tower comprising a horizontal flange extending out from the tower, and a hoist block according to any one of examples 30 to 35, engaged with the flange.
37. Wind turbine tower according to example 36, characterized in that the tower comprises a second flange which is bolted to the horizontal flange of the tower and in that the second flange comprises at least one recess which cooperates with the protrusion of the hoist block.

### Examples of the Sixth Invention

40. A wind turbine mounted crane configured to facilitate an installation, a maintenance and/or a repair of a wind turbine crane configured to facilitate an installation of a wind turbine,
   a. the crane comprising:
      i. a base portion;
      ii. a wind turbine connection mechanism connected to the base portion and configured to releasably engage with a wind turbine and arranged such that the base portion is supported by the wind turbine when the wind turbine connection mechanism of the crane is engaged with the wind turbine;
      iii. a lifting hook for lifting a load,
      iv. at least one lifting wire connected to the lifting hook,
      v. at least one winch connected to the at least one lifting wire, the winch and lifting wire being arranged such that when the at least one winch is rotated, the lifting hook moves up or down when the crane is in its main operating position, and
      vi. a boom, the boom having a lower portion and a tip portion, the lower portion of the boom being pivotally supported relative to the base portion,
   characterized in that
   b. the boom is configured to pivot relative to the base portion about a horizontal axis between a vertically downward position and a vertically upward position,
   c. in the vertically downward position, a vector connecting a lower end of the lower portion of the boom and an outer end of the tip portion of the boom forms an angle in a vertical plane of more than 80 degrees relative to a horizontal plane passing through the base portion with the tip portion being below the base portion, and
   d. in the vertically upward position, a vector connecting a lower end of the lower portion of the boom and an outer end of the tip portion of the boom forms an angle of greater than 80 degrees relative to the horizontal plane with the tip portion being arranged above the base portion.
41. A crane according to example 40, characterized in that the boom is connected to the base portion via an intermediate raise mechanism and a slew platform where the lower portion of the boom is pivotably connected to the intermediate raise mechanism about a first horizontal axis and in that the intermediate raise mechanism is pivotably connected to the slew platform about a second horizontal axis.
42. A crane according to example 41, characterized in that the first and second horizontal axes are arranged co-axial.
43. A crane according to example 41 or 42, characterized in that the slew platform and the intermediate raise mechanism are connected together via a first hydraulic actuator which is arranged to change an angle between the slew platform and the intermediate raise mechanism and in that the intermediate raise mechanism and the boom are connected together via a second hydraulic actuator which is arranged to change an angle between the intermediate raise mechanism and the boom.
44. A crane according to any one of examples 40 to 43, characterized in that the slew platform is rotatably connected to the base portion about a vertical axis.
45. A crane according to any one of examples 40 to 44, characterized in that the crane is arranged to have a first position where the boom is pivoted downwardly at an angle of greater than 80 degrees, a second position where the boom is pivoted upwardly at an angle of greater than 80 degrees and a third position where the boom is pivoted further at least 120 degrees.

### Examples of a Seventh Invention

50. Crane system comprising a hoist block and a wind turbine mounted crane configured to facilitate an installation, a maintenance and/or a repair of a wind turbine,
   a. the crane comprising:
      i. a base portion,
      ii. a wind turbine connection mechanism connected to the base portion and configured to releasably engage with a wind turbine and arranged such that the base portion is supported by the wind turbine when the wind turbine connection mechanism of the crane is engaged with the wind turbine,
      iii. a lifting hook for lifting a load,
      iv. at least one lifting wire connected to the lifting hook, and
      v. at least one winch connected to the at least one lifting wire, the winch and lifting wire being arranged such that when the at least one winch is rotated, the lifting hook moves up or down, and
      vi. at least one main crane lifting pulley block attached to the base portion,
   b. the hoist block comprising
      i. a wind turbine connection element configured to releasably engage with the wind turbine and arranged such that the hoist block is supported by the wind turbine when the wind turbine connection element is engaged with the wind turbine, and
      ii. at least one hoist pulley block,
   c. and where the lifting wire is arranged to go from the winch to the main crane lifting pulley block, to the hoist pulley block, back to the main crane lifting pulley block and up to the tip of the lifting boom and down to a lifting hook connected to a load being lifted by the crane.
51. Crane system according to example 50, characterized in that the wind turbine connection mechanism of the crane is arranged to releasably connect to a flange on a tower of the wind turbine and in that the wind turbine connection element of the hoist block is arranged to releasably connect to a flange on a tower of the wind turbine.
52. Crane system according to example 51, characterized in that the wind turbine connection mechanism of the crane comprises at least three flange connection elements spaced apart from each other for releasably connecting the crane with a flange on a tower of a wind turbine.
53. Crane system according to any one of examples 51-52, characterized in that the wind turbine connection mechanism of the crane is arranged to be releasably attached to a flange on a tower of a wind turbine and in that the wind turbine connection element of the hoist block is arranged to be releasably attached to the same flange on a tower of a wind turbine at the same time as the wind turbine connection mechanism of the crane is also releasably attached to the flange of the tower of the wind turbine.
54. Wind turbine tower comprising a flange extending outwardly from the outer surface of the tower and a crane system according to any one of examples 50-53 wherein the crane is releasably attached to the flange and the hoist block is releasably attached to the flange and a wind turbine tower section, a wind turbine nacelle, a wind turbine hub or a wind turbine blade is connected to the lifting hook of the crane.

LIST OF ELEMENTS

| | |
|---|---|
| 10 | base tower section |
| 11 | bracket |
| 12 | flange |
| 14 | top end |
| 16 | outer surface |
| 18 | recess |
| 20a | ground winch |
| 20b | ground winch |
| 50 | next tower section |
| 100 | hoist block |
| 102 | frame portion |
| 104 | first pulley block assembly |
| 106 | second pulley block assembly |
| 108 | arm |
| 110 | hoist pulley block |
| 112 | column structure |
| 114 | first end portion |
| 116 | second end portion |
| 120 | first seat |
| 122 | through opening |
| 124 | second seat |
| 126 | through opening |
| 130 | first retention structure |
| 132 | second retention structure |
| 140 | support structure |
| 142 | first sheave |
| 150 | coupler |
| 152 | pin |
| 160 | lifting structure |
| 170 | engagement structure |
| 172 | block |
| 174 | lower edge portion |
| 180 | guide structure |
| 182 | angled plate |
| 186 | pad |
| 200 | crane |
| 202a | first lifting wire |
| 202b | second lifting wire |
| 204 | base portion |
| 206 | arm |
| 210 | boom |
| 212 | lower portion |
| 214 | tip portion |
| 220 | lifting hook |
| 222 | horizontal axis |
| 224 | slew platform (first base portion) |
| 226 | raise mechanism (second base portion) |
| 228 | first horizontal axis |
| 230 | first hydraulic actuator |
| 232 | second hydraulic actuator |
| 234 | vertical axis |
| 240 | main crane body (third base portion) |
| 242 | slew mechanism |
| 244 | ring gear |
| 246 | motor |
| 248 | drive gear |
| 250 | first traction winch |
| 252 | front drum |
| 254 | first motor |
| 256 | rear drum |
| 258 | second motor |
| 260 | main crane lifting pulley block |
| 262 | beam |
| 266 | axis of rotation |
| 272 | hydraulic cylinder |
| 278 | COG |
| 280 | second traction winch |
| 282a | first wire section |
| 282b | first wire section |
| 284a | second wire section |
| 284b | second wire section |
| 300 | tower |
| 302 | blades |
| 402 | first base sheave |
| 404 | second base sheave |
| 406 | vertically oriented base sheave |
| 410 | third base sheave |
| 420 | first base portion sheave |
| 422 | second base portion sheave |
| 500 | slew pulley assembly |
| 502 | first pulley arrangement |
| 506 | second pulley arrangement |
| 510 | first support plate |
| 512 | second support plate |
| 520 | first vertical sheave |
| 522 | second vertical sheave |
| 530a | first sheave |
| 530b | second sheave |
| 530c | third sheave |
| 530d | fourth sheave |
| 540a | fifth sheave |
| 540b | sixth sheave |
| 540c | seventh sheave |
| 540d | eighth sheave |

1. A wind turbine mounted crane configured to facilitate an installation, a maintenance and/or a repair of a wind turbine, the crane comprising:
a. a base portion, comprising a main crane body and a slew platform;
b. a wind turbine connection mechanism connected to the main crane body of the base portion and configured to releasably engage with a wind turbine and arranged such that the base portion is supported by the wind turbine when the wind turbine connection mechanism of the crane is engaged with the wind turbine;
c. a boom rotatably connected to the main crane body of the base portion about a vertical axis passing through the base portion,
d. a lifting hook for lifting a load,
e. a first lifting elongated flexible member and a second lifting elongated flexible member, the first and second lifting elongated flexible members running through the main crane body of the base portion and along the boom and being connected to the lifting hook, and
f. at least one winch connected to the first and second lifting elongated flexible members, the winch and lifting elongated flexible members being arranged such that when the at least one winch is rotated, the lifting hook moves up or down,
wherein
g. the boom is configured to rotate about the vertical axis relative to the main crane body of the base portion by more than 180 degrees from an initial position in a first direction and more than 180 degrees from the initial position in a second direction opposite to the first direction.

2. A wind turbine mounted crane according to claim 1, wherein the crane further comprises:
a. a slew pulley assembly to route the first and second lifting elongated flexible members from the base portion to the lifting hook, the slew pulley assembly comprising:
i. a first pulley arrangement attached to the base portion in such a way that it rotates with the boom around the vertical axis and comprising at least two first sheaves arranged in a first horizontal plane and rotating around parallel axes,
ii. a second pulley arrangement attached to the base portion such that it rotates with the boom around the vertical axis and comprising at least two second sheaves arranged in a second horizontal plane and arranged to rotate about parallel axes,
iii. a first vertical sheave associated with the at least two first sheaves and configured to route the first lifting elongated flexible member towards the lifting hook,
iv. a second vertical sheave associated with the at least two second sheaves and configured to route the second lifting elongated flexible member towards the lifting hook,
v. a first base portion sheave attached to the main crane body of the base portion in such a way that it does not rotate with the boom, and
vi. a second base portion sheave attached to the main crane body of the base portion in such a way that it does not rotate with the boom,
b. wherein a first lifting elongated flexible member is routed from the first base portion sheave on the main crane body of the base portion to the first vertical sheave through one or more of the first sheaves of the first pulley arrangement and a second lifting wire is routed from the second base portion sheave on the main crane body of the base portion to the second vertical sheave through one or more of the second sheaves of the second pulley arrangement.

3. Wind turbine mounted crane according to claim 2, wherein the first horizontal plane is arranged above the second horizontal plane.

4. Wind turbine mounted crane according to claim 2, wherein the at least two first sheaves and the at least two second sheaves are arrayed around the axis of rotation of the first and/or second pulley arrangement.

5. Wind turbine mounted crane according to claim 2, wherein the at least two first sheaves comprise three or four sheaves and in that the at least two second sheaves comprise three or four sheaves.

6. Wind turbine mounted crane according to claim 2, wherein the first base portion sheave is arranged in the same plane as the sheaves of the first pulley arrangement and in that the second base portion sheave is arranged in the same plane as the sheaves of the second pulley arrangement.

7. Wind turbine mounted crane according to claim 2, wherein the first pulley arrangement and the second pulley arrangement are arranged between the first base portion sheave and the second base portion sheave.

8. Wind turbine mounted crane according to claim 2, wherein the first pulley arrangement and the first base portion sheave are arranged as a mirror image of the second pulley arrangement and the second base portion sheave.

9. Wind turbine mounted crane according to claim 1, wherein the crane further comprises a compensation arrangement which compensates for the lifting elongated flexible member being wrapped up on or off of the first and second pulley arrangements when the boom rotates.

10. Wind turbine mounted crane according to claim 9, wherein the compensation arrangement comprises a sensor which detects the rotation of the boom and a controller which controls the at least one winch to either retract or extend the first and/or second lifting elongated flexible member when the boom rotates.
